(19) United States
(12) Patent Application Publication
(10) Pub. No.: US 2005/0212726 A1
(43) Pub. Date: Sep. 29, 2005

(54) Method, display apparatus and burn-in reduction device for reducing burn-in on display device

(75) Inventors: Kiyoshi Namba, Izumi (JP); Takuma Yoshida, Izumi (JP)

Correspondence Address: MORGAN LEWIS & BOCKIUS LLP, 1111 PENNSYLVANIA AVENUE NW, WASHINGTON, DC, 20004, US

(73) Assignee: PIONEER PLASMA DISPLAY CORPORATION

(21) Appl. No.: 11/079,537

(22) Filed: Mar. 15, 2005

(30) Foreign Application Priority Data
Mar. 16, 2004 (JP) 2004-074712
Apr. 27, 2004 (JP) 2004-131092
Jul. 15, 2004 (JP) 2004-208895

(51) Int. Cl. G09G 3/28; G06K 9/00

(52) U.S. Cl. 345/63; 382/168

(57) ABSTRACT

Disclosed is a burn-in reduction device capable of favorably reducing burn-in on a screen. The burn-in reduction device comprises luminance level distribution detecting means for detecting a statistical distribution with respect to luminance levels of pixels of an image based on an input image signal; and luminance changing means for changing a luminance level of the input image signal in accordance with the statistical distribution detected by the luminance level distribution detecting means.

### BACKGROUND OF THE INVENTION

1. Field of the Invention

The present invention relates to a display apparatus and a burn-in reduction device for reducing burn-in on a display device, and to a method and a program for reducing burn-in on a display device.

2. Description of the Related Art

When the display device presents, for example, high luminance pixels at a white level locally displayed on the screen thereof and pixels at a black level surrounding the white pixels for a long time period, image burn-in will occur on the screen.

A conventional technique for reducing such burn-in on the screen is described in, for example, Japanese Patent Kokai No. 2000-305514.

Japanese Patent Kokai No. 2000-305514 discloses a display device comprising an APL detector 101 for detecting APL (Average Picture Level) of an image signal; a luminance controller for controlling (or changing) the luminance in accordance with a detection signal from the APL detector 101; and a plasma display panel 103 for displaying images based on an image signal from the luminance controller 102, as illustrated in FIG. 27. The luminance controller 102 is configured to control the luminance when an APL value keeps within a certain range for a predetermined time period.

However, the prior art display device described above fails to provide sufficient effect on the burn-in reduction on the screen because the prior art detects an average luminance over the screen by detecting APL. Specifically, the prior art display device cannot determine, for example, whether or not an image includes a large number of pixels at a white level, and cannot therefore detect whether or not an image predominantly includes pixels at a black level substantially over the screen while including a few number of pixels at a white level, thus failing to change the luminance of the image.

### SUMMARY OF THE INVENTION

In order to solve the problem mentioned above, it is an object of the present invention to provide a method, a program, a display apparatus and a burn-in reduction device which are capable of more successfully reducing burn-in on the screen of a display device.

According to the present invention, there is provided a burn-in reduction device for reducing screen burn-in on a display device. The burn-in reduction device comprises luminance level distribution detecting means for detecting a statistical distribution with respect to luminance levels of pixels of an image based on an input image signal; and luminance changing means for changing a luminance level of the input image signal in accordance with the statistical distribution detected by the luminance level distribution detecting means.

In one preferred example of the burn-in reduction device of the present invention, the luminance level distributing means detects the statistical distribution for an entire area of one display screen.

Alternatively, in the burn-in reduction device of the present invention, the luminance level distribution detecting means preferably detects the statistical distribution for a partial display area of one display screen.

In this event, preferably, the luminance level distribution detecting means detects the statistical distribution for each of a plurality of display areas of the one display screen, and the luminance changing means changes the luminance levels of the input image signal in accordance with the statistical distribution for at least one of the plurality of display areas.

Alternatively, in the burn-in reduction device of the present invention, the luminance level distribution detecting means includes a first luminance level distribution detecting means and a second luminance level distribution detecting means, the first luminance level distribution detecting means detecting the statistical distribution for an entire area of one display screen, and the second luminance level distribution detecting means detecting the statistical distribution for a partial display area of one display screen. In addition, the luminance changing means changes the luminance level of the input image signal in accordance with the statistical distribution detected by at least one of the first and second luminance level distribution detecting means.

Alternatively, the burn-in reduction device of the present invention preferably further comprises detection area changing means for changing a display area intended for the detection of the statistical distribution by the luminance level distribution detecting means.

In the burn-in reduction device of the present invention, preferably, the detection area changing means includes storing means for storing display area specifying data for specifying a display area intended for the detection of the statistical distribution; and specifying data re-writing means for re-writing the display area specifying data in the storing means, wherein the luminance level distribution detecting means detects the statistical distribution for a display area specified by the display area specifying data stored in the storing means.

In a preferred example of the burn-in reduction device of the present invention, the detection area changing means changes the display area intended for the detection of the statistical distribution to either an entire area of one display screen or each of a plurality of areas into which one display screen are divided.

In the burn-in reduction device of the present invention, preferably, the luminance level distribution detecting means detects a statistical distribution of the number of pixels with respect to luminance levels, and the luminance changing means changes the luminance level of the input image signal in accordance with the number of pixels at the respective luminance levels.

In the burn-in reduction device of the present invention, preferably, the luminance level distribution detecting means detects the statistical distribution of the number of pixels with respect to at least three luminance levels including a black level, a white level, and an intermediate level, and the luminance changing means changes the luminance level of the input image signal in accordance with the number of pixels at each of the three luminance levels.

In the burn-in reduction device of the present invention, the luminance changing means changes the luminance level of the input image signal in accordance with an inequality relationship among the numbers of pixels at the three luminance levels.

In the burn-in reduction device of the present invention, the luminance changing means preferably changes the luminance level of the input image signal in accordance with the number of pixels at a specific luminance level of luminance levels included in white levels.

In the burn-in reduction device of the present invention, the luminance changing means preferably changes the luminance level of the input image signal when the input image signal satisfies all of the following conditions: a first condition defining that the number of pixels at the white level is larger than a first threshold, and smaller than a second threshold; a second condition defining that the number of pixels at the intermediate level is smaller than a third threshold; a third condition defining that the number of pixels at the black level is larger than the number of pixels at the intermediate level; and a fourth condition defining that the number of pixels at the black level is larger than the number of pixels at the white level.

In the burn-in reduction device of the present invention, the third condition is preferably satisfied when the number of pixels at the black level is twice or more larger than the number of pixels at the intermediate level.

Alternatively, the third condition is preferably when the number of pixels at the black level is three times or more larger than the number of pixels at the intermediate level.

Also, the fourth condition is preferably satisfied when the number of pixels at the black level is twice or more larger than the number of pixels at the white level.

Alternatively, the fourth condition is preferably satisfied when the number of pixels at the black level is three times or more larger than the number of pixels at the white level.

In the burn-in reduction device of the present invention, the luminance changing means preferably changes the luminance level of the input image signal when the input image signal satisfies all of the conditions: one of a fifth condition defining that the number of pixels at the black level is larger than a fourth threshold, and a sixth condition defining that the number of pixels at the intermediate level is larger than the fourth threshold; and a seventh condition defining that the number of pixels at a specific luminance level of luminance levels included in white levels is larger than a fifth threshold.

In the burn-in reduction device of the present invention, the luminance level distributing means preferably detects the statistical distribution for the input image signal with respect to the luminance levels as a histogram representation.

In the burn-in reduction device of the present invention, the luminance changing means preferably changes the luminance level of the input image signal when the statistical distribution with respect to the luminance levels continues to be a distribution required for the change of the luminance level for a time period longer than a predetermined time period.

In the burn-in reduction device of the present invention, the luminance changing means preferably changes the luminance level of the input image signal by reducing a luminance of the input image signal.

In the burn-in reduction device of the present invention, the luminance changing means preferably changes the luminance level of the input image signal by reducing a luminance of a pixel at a white level.

In the burn-in reduction device of the present invention, the luminance changing means preferably changes the luminance level of the input image signal by reducing a luminance of a pixel at a specific luminance level of luminance levels included in white levels.

In the burn-in reduction device of the present invention, the luminance changing means preferably changes the luminance level of the input image signal by reducing the luminance of the pixel by a predetermined ratio.

Alternatively, in the burn-in reduction device of the present invention, the luminance changing means preferably changes the luminance level of the input image signal by reducing the luminance level of the pixel by a higher ratio as luminance levels of the surrounding pixels becomes lower.

The burn-in reduction device of the present invention preferably further comprises image dividing means for dividing an image to be displayed of the input image signal into a plurality of blocks; image combining means for combining the plurality of blocks obtained by the image dividing means; nonlinear processing means for performing nonlinear processing on at least one of the blocks obtained by the image dividing means, before the combination of the blocks by the image combining means; and operation mode selecting means for selecting either a first operation mode or a second operation mode, the first operation mode being a mode in which an image signal having the luminance level changed by the luminance changing means is supplied for display, and the second operation mode being a mode in which an image signal on which image processing is performed by the image dividing means, the image combining means and the nonlinear processing means is supplied for display.

In the burn-in reduction device of the present invention, the image dividing means preferably divides the image into a plurality of blocks in accordance with the statistical distribution detected by the luminance level distribution detecting means.

In this configuration, preferably, the image dividing means divides the image into a relatively dark image and a relatively bright image, and the nonlinear processing means performs nonlinear processing on the relatively dark image so as to increase the number of gradation levels.

Alternatively, preferably, the image dividing means divides the image into an image relatively likely to cause screen burn-in and an image relatively unlikely to cause screen burn-in, and the nonlinear processing means performs nonlinear processing on the image relatively likely to cause screen burn-in so that screen burn-in is reduced.

Alternatively, preferably, the image dividing means divides the image into a relatively dark image and a relatively bright image, and the nonlinear processing means performs the nonlinear processing so that a difference in luminance between the relatively dark image and the relatively bright image is reduced.

Preferably, the burn-in reduction device of the present invention further comprises borderline specifying operation means for specifying a borderline in an image to be divided, wherein the image dividing means divides the image into a plurality of blocks based on the specifying operation by the borderline specifying operation means.

In the burn-in reduction device of the present invention, the nonlinear processing means performs the nonlinear processing on at least one of the blocks after the division by the image dividing means and before the combination of the blocks by the image combining means, in accordance with the statistical distribution detected by the luminance level distribution detecting means.

In the burn-in reduction device of the present invention, the nonlinear processing means performs the nonlinear processing on each of the blocks after the division by the image dividing means and before the combination of the blocks by the image combining means, respectively and separately.

In the burn-in reduction device of the present invention, preferably, the luminance level distribution detecting means detects the statistical distribution with respect to luminance levels of pixels included in at least one of the blocks obtained by the image dividing means, and the nonlinear processing means performs the nonlinear processing on at least one of the blocks in accordance with the statistical distribution detected by the luminance level distribution detecting means.

In the burn-in reduction device of the present invention, preferably, the luminance level distribution detecting means detects the statistical distribution with respect to luminance levels of pixels included in each of the blocks obtained by the image dividing means, and the nonlinear processing means performs the nonlinear processing respectively and separately on each of the blocks obtained by the image dividing means in accordance with corresponding statistical distribution selected from the statistical distributions detected by the luminance level distribution detecting means.

In the burn-in reduction device of the present invention, the image dividing means determines an image area to be divided by the image dividing means, on the basis of at least one of the following results: a result obtained by dividing an image to be displayed over a display screen into blocks of a first division number and detecting the statistical distribution for each of the blocks by the luminance level distribution detecting means; and a result obtained by dividing the image to be displayed over the display screen into blocks of a second division number larger than the first division number and detecting the statistical distribution for each of the blocks by the luminance level distribution detecting means.

In the burn-in reduction device of the present invention, the luminance level distribution detecting means determines an image area to be divided by the image dividing means, at least through a process in which a range of the image area intended for detection of the statistical distribution by the luminance level distribution detecting means is reduced by stages.

The burn-in reduction device of the present invention preferably further comprises determining means for determining whether or not the image dividing means and the nonlinear processing means should divide an image into a plurality of blocks and perform the nonlinear processing, respectively, when the second operation mode is selected.

In this configuration, the determining means preferably makes the determination based on the statistical distribution detected by the luminance level distribution detecting means.

The burn-in reduction device of the present invention preferably comprises boundary image processing means for smoothing an image of a boundary area between the plurality of blocks obtained by the image dividing means.

In this configuration, preferably, the image dividing means supplies an image signal corresponding to the image of a boundary area between the plurality of blocks to the boundary image processing means, and the boundary image processing means smooths an image of an image signal supplied from the image dividing means and outputs the smoothed image signal to the image combining means.

In the burn-in reduction device of the present invention, the boundary image processing means preferably performs processing so as to gradually change a luminance or color of pixels in the boundary area between two adjoining blocks, from a luminance or color of one of the two adjoining blocks to a luminance or color of the other block, as the pixels get closer to the other block.

In the burn-in reduction device of the present invention, the boundary image processing means includes a two-dimensional lowpass filter.

In the burn-in reduction device of the present invention, preferably, the burn-in reduction device further comprises smoothing processing valid/invalid selecting operation means for selecting either validity or invalidity of smoothing processing by the boundary image processing means, wherein: when an operation of selecting the validity is performed in the smoothing processing valid/invalid selecting operation means, the image combining means combines the smoothed image signal from the boundary image processing means and image signals corresponding to the image divided by the image dividing means; and when an operation of selecting the invalidity is performed, the image combining means combines only image signals except the smoothed image signal from the boundary image processing means.

In the burn-in reduction device of the present invention, preferably, the burn-in reduction device further comprises boundary area range specifying operation means for specifying a range of the display area of the boundary area in which an image is to be smoothed by the boundary image processing means, wherein the boundary image processing means performs smoothing of an image in a range specified by the boundary area range specifying operation means.

In one preferred example of the burn-in reduction device of the present invention, the nonlinear processing means performs gamma processing as the nonlinear processing.

Alternatively, in the burn-in reduction device of the present invention, the nonlinear processing means preferably performs contrast control processing, sharpness control processing, noise reduction processing or color correction processing as the nonlinear processing.

Alternatively, in the burn-in reduction device of the present invention, the nonlinear processing means preferably performs at least one of gamma processing, contrast control processing, sharpness control processing, noise reduction processing and color correction processing, as the nonlinear processing.

In the burn-in reduction device of the present invention, preferably, the burn-in reduction device further comprises nonlinear processing specifying operation means for specifying an operation mode of a nonlinear processing to be performed by the nonlinear processing means, wherein, the nonlinear processing means performs nonlinear processing in a manner depending on an operation mode specified by the nonlinear processing specifying operation means.

According to the present invention, there is provided a display apparatus comprising the burn-in reduction device and a display unit for displaying an image based on the input image signal.

In one preferred example, the display device of the present invention is a plasma display device including a plasma display panel as the display unit.

In this configuration, it is preferable that the luminance changing means gradually changes a sustain frequency in the plasma display panel upon the change of the luminance level.

According to the present invention, there is provided a method of reducing screen burn-in on a display device. The method comprises the steps of: detecting a statistical distribution with respect to luminance levels of pixels of an image based on an input image signal; and changing a luminance level of the input image signal in accordance with the statistical distribution detected.

According to the present invention, there is provided a program executable by a computer. The program causes the computer to perform the steps of: detecting a statistical distribution with respect to luminance levels of pixels of an image based on an input image signal; and changing a luminance level of the input image signal in accordance with the statistical distribution.

According to the present invention, since the burn-in reduction device comprises luminance level distribution detecting means for detecting a statistical distribution with respect to luminance levels of pixels of an image based on an input image signal, and luminance changing means for changing a luminance level of the input image signal in accordance with the statistical distribution detected by the luminance level distribution detecting means, the burn-in can be reduced in a more favorable manner than before.

Specifically, for example, the luminance level distribution detecting means makes it possible to detect a ratio of white levels, and the luminance changing means can change luminance when the ratio of the white levels is predominant.

Further, even when a display image including, for example, a clock image, predominantly includes pixels at black level on a screen and includes a small number of pixels at the white levels, such a display image can be detected to change luminance.

Moreover, according to the present invention, the method of reducing burn-in on a screen in a display device comprises the steps of detecting a statistical distribution with respect to luminance levels of pixels of an image based on an input image signal, and changing a luminance level of the input image signal in accordance with the statistical distribution, so that the burn-in can be reduced in a more favorable manner than before.

Additionally, according to the present invention, the burn-in reduction device may further comprise image dividing means for dividing an image to be displayed of the input image signal into a plurality of blocks; image combining means for combining the plurality of blocks obtained by the image dividing means; nonlinear processing means for performing nonlinear processing on at least one of the blocks obtained by the image dividing means, before the combination of the blocks by the image combining means; and operation mode selecting means for selecting either a first operation mode or a second operation mode, the first operation mode being a mode in which an image signal having the luminance level changed by the luminance changing means is supplied for display, and the second operation mode being a mode in which an image signal on which image processing is performed by the image dividing means, the image combining means and the nonlinear processing means is supplied for display. In this burn-in reduction device, for example, when a portion of an image to be displayed of an input image signal is likely to cause screen burn-in, the screen burn-in can be reduced by applying nonlinear processing only to the portion of the image such that a light/dark difference of the image is reduced, whereas the remaining part of the image can be displayed with normal brightness by applying nonlinear processing for displaying with normal brightness or not applying nonlinear processing. Also, when a part of a display screen displays an image so as to highlight a white color and the remaining part of the display screen displays a dark image, the dark image can be seen clearly by applying nonlinear processing to the dark image so as to increase the number of grayscale levels and thereby improve the image quality.

### BRIEF DESCRIPTION OF THE DRAWINGS

FIG. 1 is a block diagram illustrating a configuration of a display device which is an embodiment of the present invention;

FIG. 2 includes diagrams for explaining the operation, wherein FIG. 2(A) illustrates an example of an image displayed on a screen, and FIG. 2(B) illustrates a luminance level distribution as a histogram representation when the image of FIG. 2(A) is displayed;

FIG. 3 is a graph illustrating an example of a luminance level distribution as a histogram representation;

FIG. 4 is a graph illustrating an example of a luminance level distribution as a histogram representation;

FIG. 5 is a graph illustrating an example of a luminance level distribution as a histogram representation;

FIG. 6 is a graph illustrating an example of a luminance level distribution as a histogram representation;

FIG. 7 is a graph illustrating an example of a luminance level distribution as a histogram representation;

FIG. 8 is a graph illustrating an example of a luminance level distribution as a histogram representation;

FIG. 9 is a graph illustrating an example of a luminance level distribution as a histogram representation;

FIG. 10 is a flow chart illustrating a main control procedure executed by the display device of FIG. 1;

FIG. 11 is a block diagram illustrating the configuration of a display device which is an exemplary modification of the embodiment of FIG. 1;

FIG. 12 includes diagrams for explaining an operation in a second embodiment of the present invention, wherein FIG. 12(A) illustrates an example of an image displayed on a screen, and FIG. 12(B) illustrates a luminance level distribution as a histogram representation when the image of FIG. 12(A) is displayed;

FIG. 13 includes diagrams for explaining an operation, like FIG. 12, wherein FIG. 13(A) illustrates another example of an image displayed on the screen, and FIG. 13(B) illustrates a luminance level distribution as a histogram representation when the image of FIG. 13(A) is displayed;

FIG. 14 is a block diagram illustrating a configuration of a display device which is a third embodiment of the present invention;

FIG. 15 is a block diagram illustrating a configuration of a display device which is a fourth embodiment of the present invention;

FIG. 16 is a flow chart illustrating a main control procedure executed by the display device of FIG. 15;

FIG. 17 includes diagrams for explaining luminance level correction in a fifth embodiment of the present invention, wherein FIG. 17(A) illustrates a screen display where a display area R1 at a white level is surrounded by a display area R2 entirely in black, and FIG. 17(B) illustrates a screen display where a display area R1 at a white level is surrounded by a display area R2 entirely in white;

FIG. 18 illustrates an exemplary correction curve used for luminance level correction in the fifth embodiment;

FIG. 19 is a block diagram illustrating a configuration of a display device which is a sixth embodiment of the present invention;

FIG. 20 illustrates another example of division of an image in the sixth embodiment;

FIG. 21 is a block diagram illustrating a configuration of a display device which is a seventh embodiment of the present invention;

FIG. 22 is a block diagram illustrating a configuration of a display device which is an eighth embodiment of the present invention;

FIG. 23 illustrates an operation of the display device of FIG. 22;

FIG. 24 is a block diagram illustrating another exemplary configuration of the display device of the eighth embodiment;

FIG. 25 is a block diagram illustrating a configuration of a display device which is a ninth embodiment of the present invention;

FIG. 26 is a block diagram illustrating a configuration of a display device which is a tenth embodiment of the present invention;

FIG. 27 is a block diagram illustrating a configuration of a conventional display device.

### DETAILED DESCRIPTION OF THE INVENTION

In the following, various embodiments of the present invention will be described with reference to the drawings.

### First Embodiment

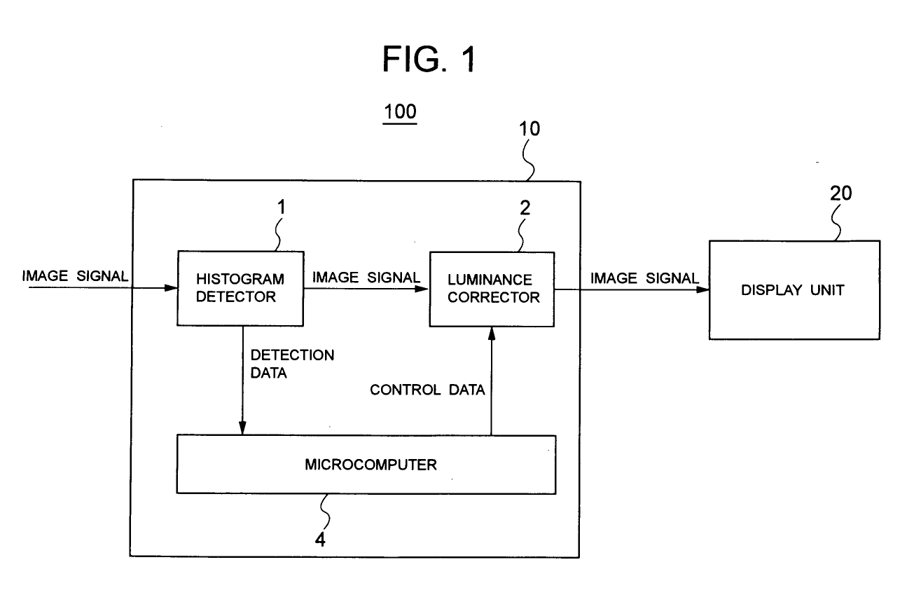

FIG. 1 is a block diagram illustrating a configuration of a display device 100 which is a first embodiment.

As illustrated in FIG. 1, the display device 100 according to the first embodiment comprises a burn-in reduction unit (burn-in reduction device) 10 for reducing burn-in on a display screen by luminance correction processing on an input image signal; and a display unit 20 for receiving the image signal corrected or not corrected by a luminance corrector 2 (to be described later) of the burn-in reduction unit 10 and for displaying an image based on the received image signal.

Among these, the burn-in reduction unit 10 comprises a histogram detector (luminance level distribution detecting means) 1 for detecting a statistical distribution as a histogram representation with respect to luminance levels of pixels included in an image based on the input image signal; a luminance corrector 2 for receiving an image signal through the histogram detector 1 to change or correct the luminance level of the image signal as required; and a microcomputer 4 for receiving data representing the statistical distribution detected by the histogram detector 1.

The microcomputer 4 and luminance corrector 2 constitute luminance changing means.

The microcomputer 4 comprises a CPU (Central Processing Unit) and a memory, and a program for causing the CPU to control the system is stored in the memory. The CPU, and consequently the microcomputer 4 operate according to the program.

Also, in this embodiment, the display device 100 is, for example, a plasma display device including a plasma display panel as the display unit 20.

In this embodiment, the histogram detector 1 detects, for example, a statistical distribution with respect to luminance levels (hereinafter referred to as the “luminance level distribution”) of pixels included in an image displayed over a display screen (an entire display screen) of the display unit 20.

More specifically, the histogram detector 1 is configured to detects a statistical distribution of the number of pixels with respect to their respective luminance levels, and to supply the statistical distribution as a histogram representation.

Further specifically, the histogram detector 1 is configured to detect a statistical distribution of the number of pixels with respect to three luminance levels, for example, a black level, a white level, and an intermediate level between the black and white levels, and to supply the statistical distribution as a histogram representation.

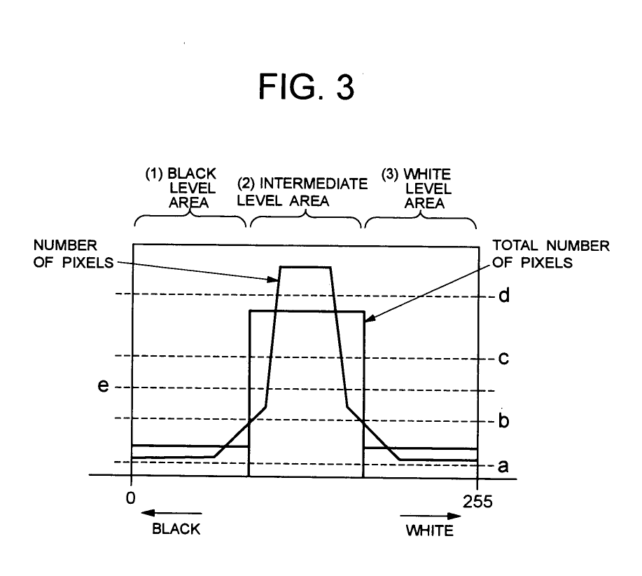

For example, as illustrated in FIGS. 3 to 9, the histogram detector 1 divides a histogram into three luminance level areas, i.e., (1) a black level area (black levels), (2) an intermediate level area (intermediate levels), and (3) a white level area (white levels), counts a total number of pixels in each area, and provides the result of the counts as a histogram representation.

Line graphs illustrated in FIGS. 3 to 9 indicate the numbers of pixels at their respective luminance levels, and three total numbers of the numbers of pixels at the luminance levels included in the respective areas (1)-(3) as a histogram representation.

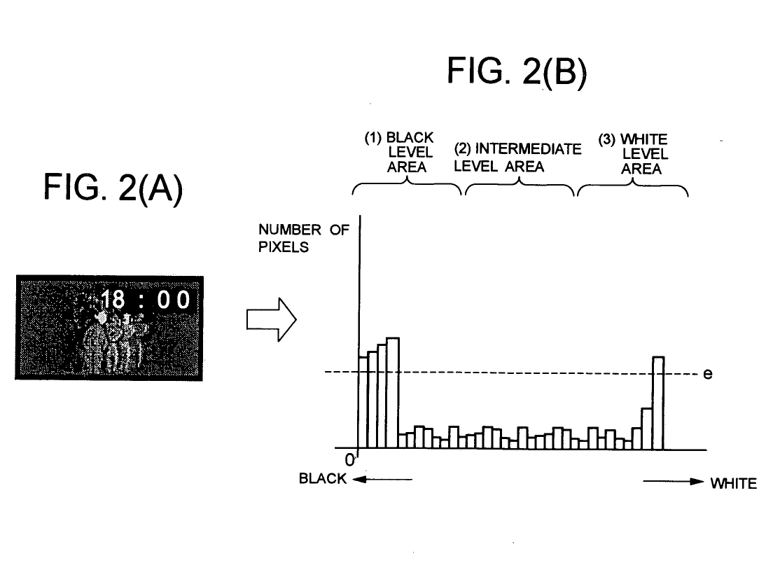

In FIG. 2(B) and FIGS. 3 to 9, the luminance is higher toward the right, and lower toward the left.

For example, as illustrated in FIGS. 3 to 9, when the number of grayscale levels or luminance gradation levels 0-255 is 256, 86 luminance gradation levels 0-85 may be included in the black level area (1); 85 luminance gradation levels 86-170 in the intermediate level area (2); and 85 luminance gradation levels 171-255 in the white level area (3).

Further, the histogram detector 1 may be configured to sub-divide the luminance levels included in each of the areas (1)-(3) into three groups, as illustrated in FIG. 2(B) to detect a distribution of the number of pixels at each of the groups of luminance levels as a histogram representation.

Here, black level area (1), intermediate level area (2), and white level area (3) indicate the total numbers of pixels in the respective sub-ranges into which a range of luminance levels 0-1024 (for a digital 10-bit signal) of an image signal is divided. With respect to the total numbers of pixels in the respective level areas, a relational equation is given by the following expression:
(1) Total Number of Pixels in Black Level Area+(2) Total Number of Pixels in Intermediate Level Area+(3) Total Number of Pixels in White Level Area=Total number of Pixels in One Display Screen (Resolution), (for example, 640*480=30720 for VGA).

The histogram detector 1 transfers data representing the luminance level distribution (hereinafter referred to as the “luminance level distribution data) detected in the manner described above, to the microcomputer 4.

The microcomputer 4 determines whether or not burn-in is likely to occur on the display screen of the display unit 20 in accordance with the luminance level distribution data from the histogram detector 1, and transfers control data to the luminance corrector 2 to allow the luminance corrector 2 to perform a luminance level correcting operation when it determines that the burn-in is likely to occur.

Here, the total numbers of pixels included in the black level area (1), in the intermediate level area (2), and in the white level area (3) are simply designated by (1), (2), and (3), respectively. The determination as to whether or not the luminance level should be corrected is made based on one or a combination of a plurality of the following criterion conditions A, B, C:
Condition A: the values of (1), (2), (3), in accordance with which the luminance level is corrected (the luminance level of the input image signal is corrected in accordance with the number of pixels at each of the three luminance levels).
Condition B: an inequality relationship among the values of (1), (2), (3), in accordance with which the luminance level is corrected (the luminance level of the input image signal is corrected in accordance with the relationship among (1), (2), (3)).
Condition C: the number of pixels at a specific luminance level (gradation level) in a white level area (hereinafter simply designated by (4)), in accordance with which the luminance level is corrected.

In this embodiment, more specifically, in order to determine whether or not the luminance level should be corrected, for example, conditions D, E described below are used.

<Condition D>

Condition D is satisfied when all of the following first, second, third and fourth conditions are satisfied as illustrated in FIG. 5:
the first condition “First Threshold a <(3)<Second Threshold b,”
the second condition “(2)<Third Threshold c,”
the third condition “(1)>>(2),” and
the fourth condition “(1)>>(3),”
where, for example, “Second Threshold b<Third Threshold c” can be established.

Specifically, (1)>>(2) means, for example, that (1) is twice or more or three times or more as large as (2).

(1)>>(3) specifically means, for example, that (1) is twice or more or three times or more as large as (3).

<Condition E>

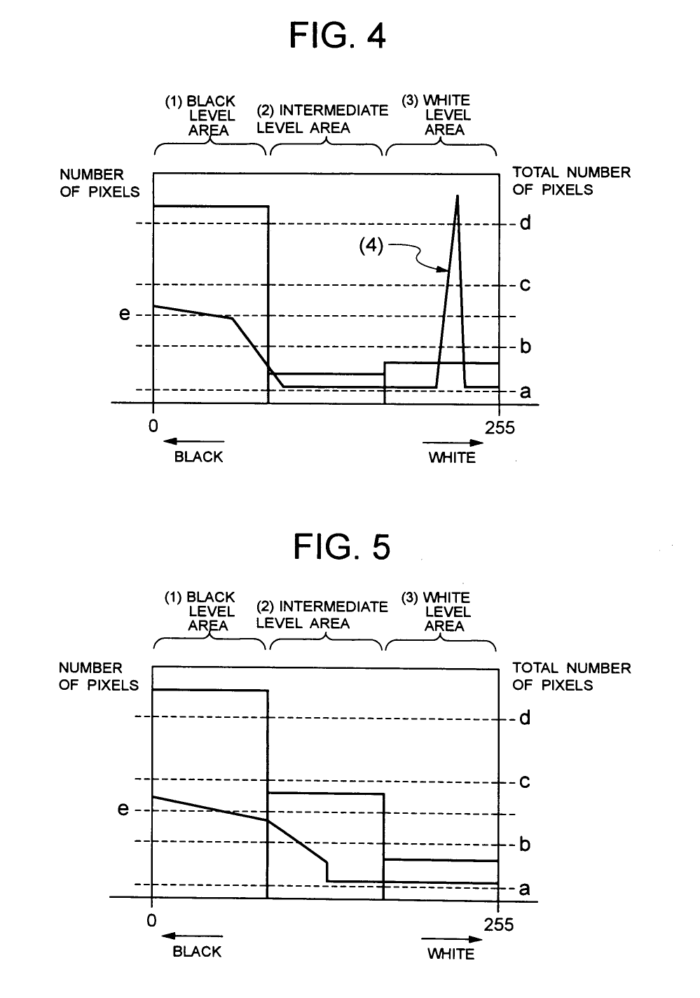

Condition E is satisfied when either one of the following fifth or sixth conditions is satisfied and the following seventh condition is satisfied as illustrated in FIG. 4:
the fifth condition “(1)>Fourth Threshold d,”
the sixth condition “(2)>Fourth Threshold d,” and
the seventh condition “(4)>Fifth Threshold e,”
where, for example, “Third Threshold c<Fourth Threshold d” can be established.

Also, for example, “Second Threshold b<Fifth Threshold e<Third Threshold c” is established.

The microcomputer 4 determines that the screen burn-in is likely to occur when a state satisfying the foregoing condition D or E continues at least for a predetermined time period a (for example, 30 seconds or one minute) in total, and then transfers control data to the luminance corrector 2 to allow the luminance corrector 2 to perform a correcting operation for the luminance level.

On the other hand, in the cases of FIGS. 3, 6, 7, 8, and 9 which do not fall under any of the condition D and condition E, or in the case where a state satisfying the condition D or condition E but continues only for less than the predetermined time period a, the luminance level is not corrected.

A sub-division of the luminance level distribution illustrated in FIG. 4, which falls under the condition E, results in a luminance level distribution similar to that illustrated in FIG. 2(B). The luminance level distribution illustrated in FIG. 2(B) is presented for a screen display illustrated in FIG. 2(A) where a clock image is displayed in white at high luminance at the upper left corner of the screen which is dim almost over the entirety. When the screen display state as illustrated in FIG. 2(A) continues for some time, the screen display state is likely to cause screen burn-in. In this event, the luminance level distribution detected by the histogram detector 1 presents a relatively large number of (1) and an outstanding peak in (4).

A luminance level distribution illustrated in FIG. 5, which falls under the condition D, is found when a screen display includes a large number of (1) and also a large number of (4) to some degree, but without an outstanding peak in (4). Such a state is also likely to cause the screen burn-in as is the case with FIG. 4, so that the luminance level should be corrected.

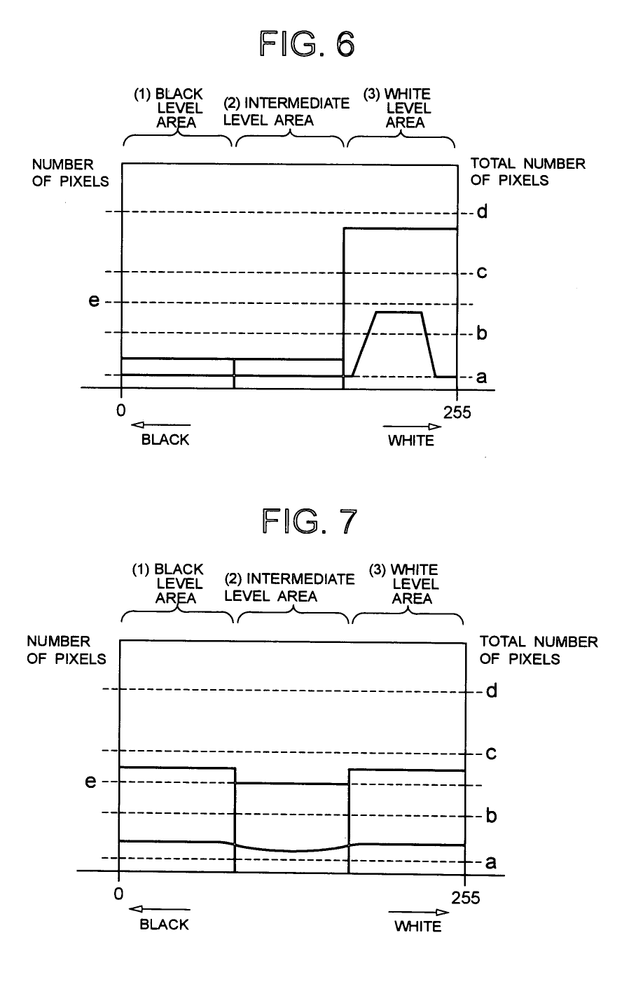

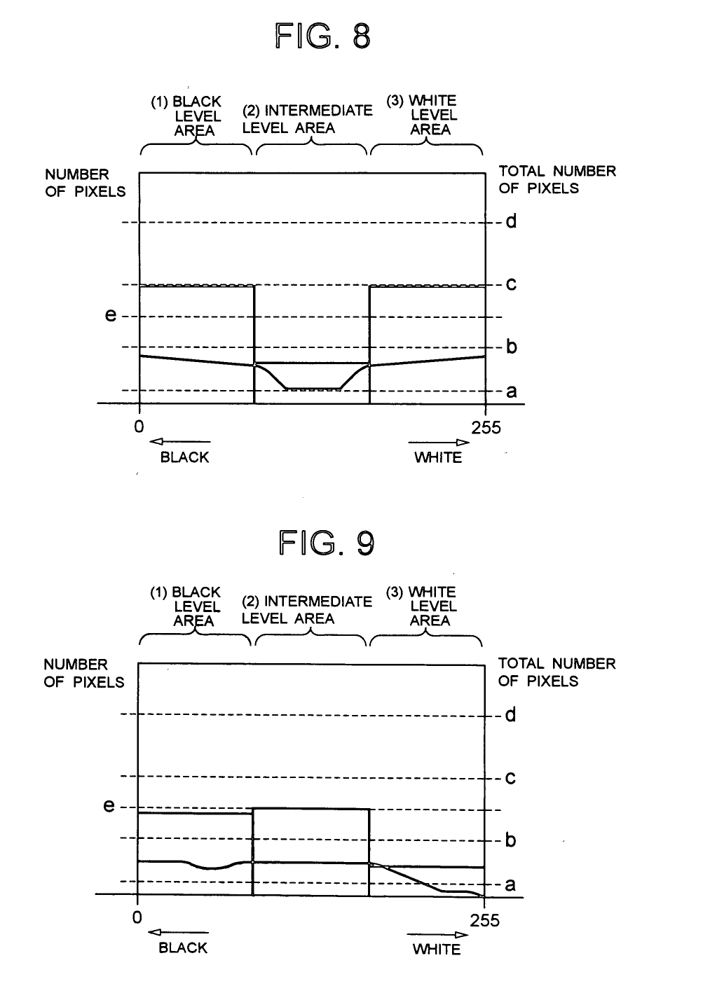

When there are a large number of (2) and small numbers of (1) and (3) as illustrated in FIG. 3, or when there are a large number of (3) but a small number of (1) as illustrated in FIG. 6, or when there are like numbers of (1)-(3) as illustrated in FIG. 7, or when there is slightly more numbers of (1) and (3) than (2), but like numbers of (1) and (3) as illustrated in FIG. 8, or when there is a small number of (3) and no peak in (4) as illustrated in FIG. 9, it is determined that no screen burn-in can occur, and the luminance level is not corrected because the screen burn-in is unlikely to occur.

As described above, the microcomputer 4 transfers control data to the luminance corrector 2 for correcting the luminance level when the number of pixels at the white level is equal to or larger than a predetermined value or more.

The luminance corrector 2 corrects the luminance level of the input image signal fed through the histogram detector 1 when control data is transferred from the microcomputer 4 for correcting the luminance level.

Here, the luminance corrector 2 corrects the luminance level by, for example, reducing the luminance levels of pixels at the white level by a predetermined ratio (for example, equally for all pixels of (3)). Specifically, this correction may be made, for example, by reducing the luminance of the pixels at the white level to be corrected to 70% or lower (specifically, for example, reducing to 70%, or in other words, reducing by 30%). Alternatively, the correction may be made by reducing the luminance of pixels at the white level to 50% or lower (specifically, for example, reducing to 50%, or in other words, reducing by 50%).

Alternatively, the correction is preferably made to reduce the luminance of specific ones of pixels in the white level area, i.e., pixels at luminance levels close to the white peak in (4). This correction may be made, for example, by reducing pixels at luminance levels near the white peak of (3) to 70% or lower (specifically, for example, to 70%), or reducing to 50% (specifically, for example, to 50%).

Here, the luminance corrector 2 makes the correction by gradually changing a sustain frequency in the display unit 20 such that the correction for the luminance is not perceived by a person who is viewing the display screen of the display unit 20.

The luminance corrector 2 transfers the input image signal corrected as required in the foregoing manner to the display unit 20. The input image signal is the corrected input image signal when determined that screen burn-in can occur, or a non-corrected input image signal when determined that no screen burn-in can occur.

The display unit 20 displays an image based on the input image signal from the luminance corrector 2 on its display screen (not shown).

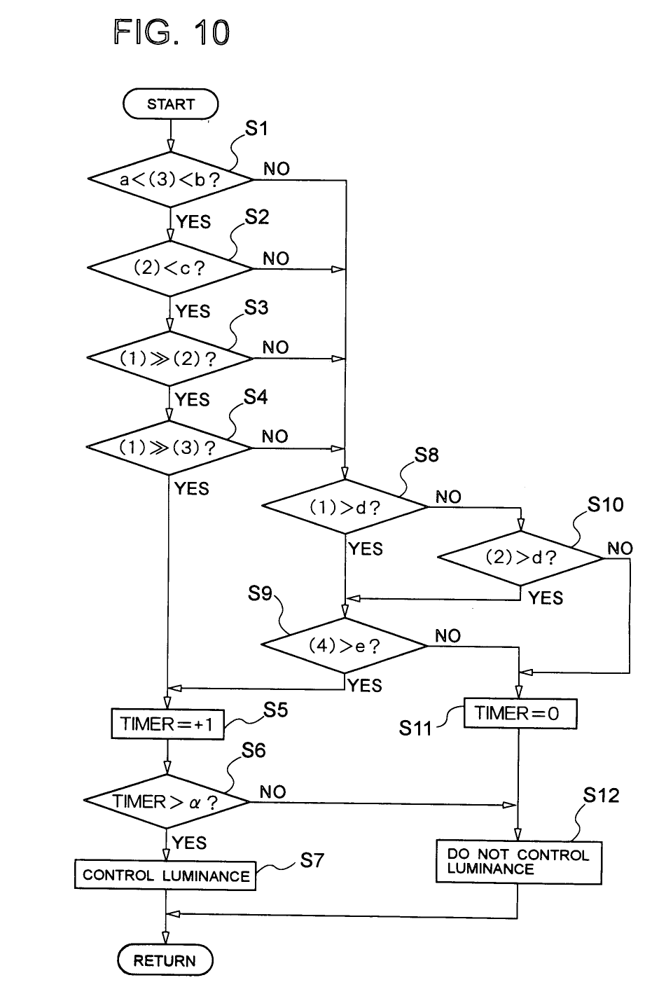

Next, the operation of the microcomputer 4 will be described with reference to the flow chart of FIG. 10.

The processing illustrated in FIG. 10 is repeatedly performed by the microcomputer 4 at predetermined intervals.

First, the microcomputer 4 determines at step S1 whether or not the first condition, i.e., “First Threshold a<(3) Number of Pixels at White Level<Second Threshold b” is established.

When the microcomputer 4 determines that the first condition is established (YES at step S1), the processing proceeds to step S2, where the microcomputer 4 determines whether or not the second condition, i.e., “(2) Number of Pixels at Intermediate Level<Third Threshold c” is established.

When the microcomputer 4 determines that the second condition is established (YES at step S2), the processing proceeds to step S3, where the microcomputer 4 determines whether or not the third condition, i.e., “(1) Number of Pixels at Black Level >>(2) Number of Pixels at Intermediate Level” is established.

When the microcomputer 4 determines that the third condition is established, the processing proceeds to step S4, where the microcomputer 4 determines whether or not the fourth condition, i.e., “(1) Number of Pixels at Black Level >>(3) Number of Pixels at White Level” is established.

When the microcomputer 4 determines that the fourth condition is established (YES at step S4), i.e., determines that all the first to fourth conditions are established, the processing proceeds to step S5.

The foregoing steps S1-S4 make up a process for determining whether or not the aforementioned condition D is established.

At step S5, the microcomputer 4 increments the count value of the timer by “1.”

At subsequent step S6, the microcomputer 4 determines whether or not the count value of the timer is larger than a value equivalent to a predetermined time period a (for example, 30 seconds or one minute).

When the microcomputer 4 determines that the count value of the timer is larger than the value equivalent to the predetermined time a (YES at step S6), the microcomputer 4 determines that screen burn-in can occur, and the processing proceeds to step S7, where the microcomputer 4 transfers control data to the luminance corrector 2 for controlling the luminance, followed by a repetition of the processing again from step S1 onward.

On the other hand, when the microcomputer 4 determines at step S6 that the count value of the timer is not larger than the value corresponding to the predetermined time a (NO at step S6), the microcomputer 4 determines that no screen burn-in can occur, and the processing proceeds to step S12, where the microcomputer 4 again repeats the processing from step S1 onward without controlling the luminance (without transferring control data to the luminance corrector 2).

Also, when the microcomputer 4 determines that any of the first to fourth conditions is not established (NO at any of steps S1 to S4), i.e., the aforementioned condition D is not established, the processing proceeds to step S8.

At step S8, the microcomputer 4 determines whether or not the fifth condition, i.e., “(1) Number of Pixels at Black Level>Fourth Threshold d” is established.

When the microcomputer 4 determines that the fifth condition is established (YES at step S8), the processing proceeds to step S9, where the microcomputer 4 determines whether or not the seventh condition, i.e., “(4) Number of Pixels at Particular Level within White Level>Fifth Threshold e” is established.

When the microcomputer 4 determines that the seventh condition is established (YES at step S9), i.e., determines that both the fifth condition and seventh condition are established, the processing proceeds to step S5. The processing at step S5 onward is similar to the foregoing.

On the other hand, when the microcomputer 4 determines at step S9 that the seventh condition is not established (NO at step S9), the microcomputer 4 determines that no screen burn-in can occur, and the processing proceeds to step S11, where the microcomputer 4 resets the count value of the time (to zero), and the processing proceeds to step S12, where the microcomputer 4 again repeats the processing at step S1 onward without controlling the luminance.

Also, when the microcomputer 4 determines at step S8 that the fifth condition is not established (NO at step S8), the processing proceeds to step S10, where the microcomputer 4 determines whether or not the sixth condition, i.e., “(2) Number of Pixels at Intermediate Level>Fourth Threshold d” is established.

When the microcomputer 4 determines that the sixth condition is established (YES at step 10), the processing proceeds to step S9, where the microcomputer 4 determines whether or not the seventh condition, i.e., “(4) Number of Pixels at Particular Level in White Level>Fifth Threshold e” is established.

When the microcomputer 4 determines that the seventh condition is established (YES at step S9), i.e., determines that both the sixth condition and seventh condition are established, the processing proceeds to step S5. The processing at step S5 onward is similar to the foregoing.

Also, when the microcomputer 4 determines at step S10 that the sixth condition is not established (NO at step S10), the processing proceeds to step S11, where the microcomputer 4 performs the processing at step S11 onward in a manner similar to the foregoing.

The foregoing steps S8-S10 make up a process for determining whether or not the aforementioned condition E is established.

As described above, according to the first embodiment, since the display device 10 comprises the histogram detector 1 for detecting the statistical distribution of pixels included in an image according to luminance levels based on the input image signal; and the microcomputer 4 and luminance corrector 2 which make up luminance changing means for correcting the luminance level of the input image signal in accordance with the statistical distribution detected by the histogram detector 1, the display device 10 can more favorably reduce the burn-in than before and can enhance image quality.

Specifically, for example, the proportion of the respective luminance levels of (1)-(3) can be detected by the histogram detector 1, and the luminance can be corrected, for example, when there is a larger proportion of pixels at the white level of (3). Also, even when a displayed image predominantly includes pixels at the black level on the screen with a small number of pixels at the white level, such a display can be detected to correct the luminance.

Particularly, since the histogram detector 1 can display the luminance level distribution in histogram representation, the luminance can be favorably corrected.

Also, such a correction for the luminance can produce a secondary effect of reducing power consumption.

Exemplary Modification

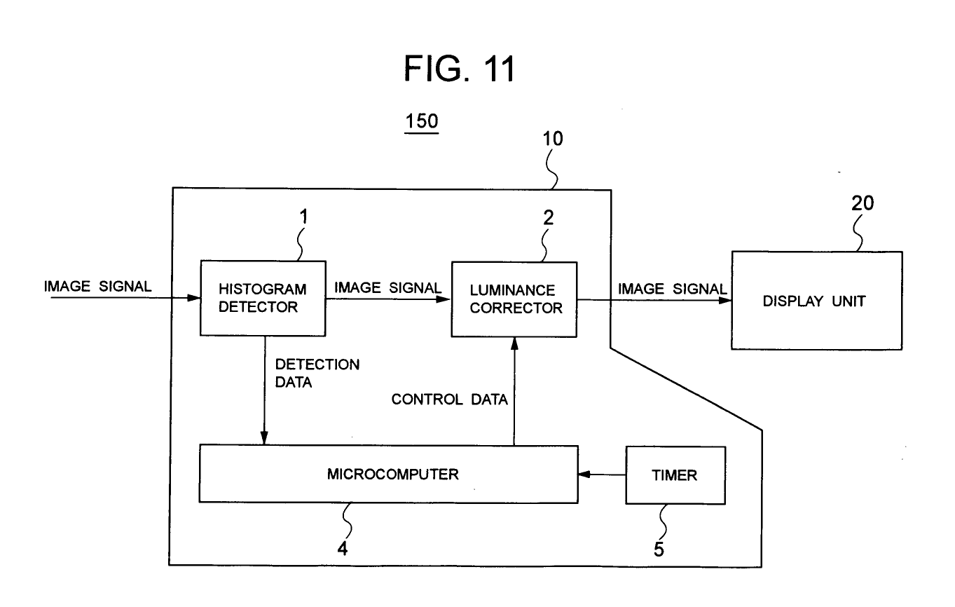

FIG. 11 is a block diagram illustrating the configuration of a display device 150 which is an exemplary modification of the first embodiment.

Since the display device 150 illustrated in FIG. 11 is different from the display device 100 of the foregoing first embodiment only in that the display device 150 further comprises a timer 5, and is configured similarly to the display device 100 in other respects, the components in the display device 150 similar to those in the display device 100 have the same reference numerals and the descriptions thereof are omitted.

While the first embodiment has shown an example in which the predetermined time a is counted by incrementing the count value by the microcomputer 4, as in the case of the display device 150 illustrated in FIG. 11, the display device may additionally comprise a timer 5 (or timer IC) for performing a time measuring operation to provide its measured time data to the microcomputer 4, such that the microcomputer 4 monitors the predetermined time a based on the measured time data from the timer 5. In this configuration, the microcomputer 4, timer 5, and luminance corrector 2 make up luminance changing means.

### Second Embodiment

While the foregoing first embodiment has been described for an example in which a luminance level distribution is detected over the entire display screen to correct the luminance level, a second embodiment will be described for an example in which a luminance level distribution is detected in a partial display area of one display screen to correct the luminance level in this display area.

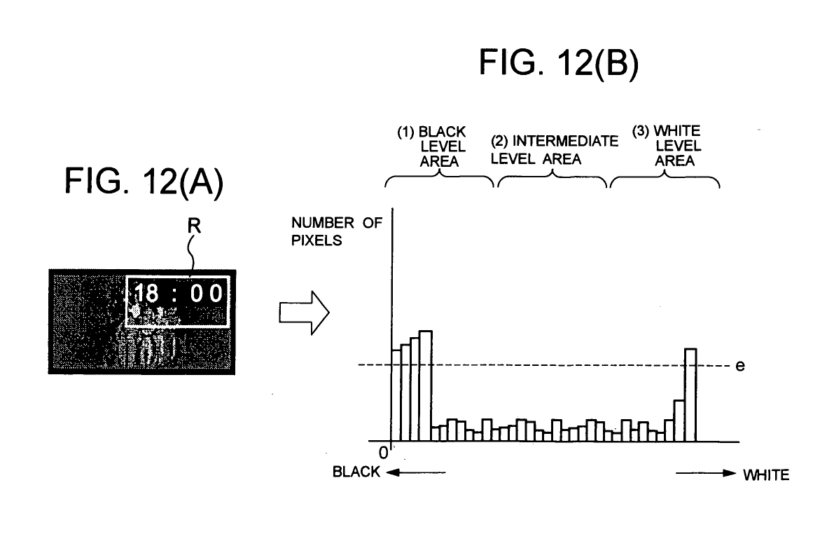

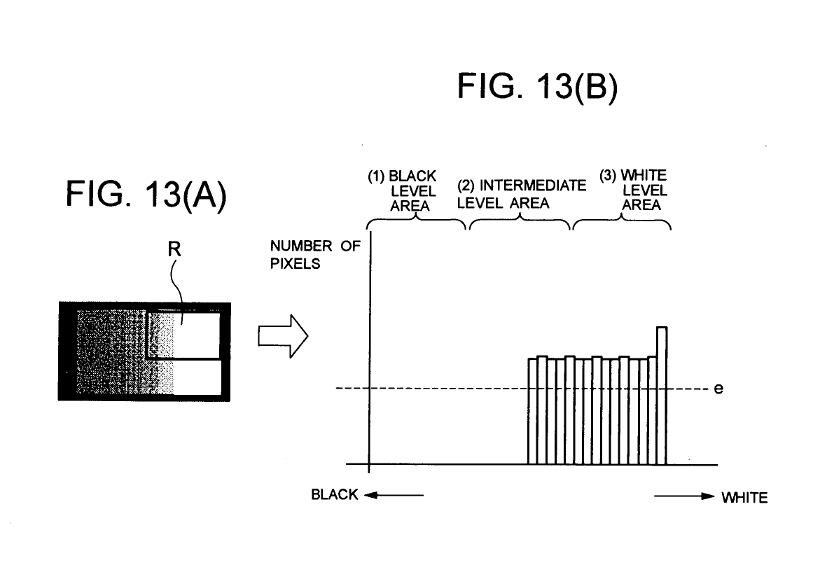

FIG. 12 and FIG. 13 include diagrams illustrating operations of the second embodiment, wherein FIG. 12(A) illustrates an example of an image displayed on a screen, and FIG. 12(B) illustrates a luminance level distribution as a histogram representation when the image of FIG. 12(A) is displayed. Also, FIG. 13(A) illustrates another example of an image displayed on a screen, and FIG. 13(B) illustrates a luminance level distribution as a histogram representation when the image of FIG. 13(A) is displayed.

Also in the second embodiment, the configuration of the display device 100 is similar to that of the foregoing first embodiment.

For example, a clock image or a channel number image tends to be displayed near a corner of the screen (for example, near the upper right corner).

Therefore, in the second embodiment, the histogram detector 1 detects a luminance level distribution only for a partial display area R (for example, near the upper right corner) of the display screen, as illustrated in FIGS. 12 and 13.

In this second embodiment, the microcomputer 4 determines, for example, whether or not a display satisfies condition F defining that the number of pixels at a specific luminance level of luminance levels included in white levels is equal to or larger than a fifth threshold e, and corrects the luminance level when it determines that the condition F is satisfied. In this way, a clock image, a channel number image or the like displayed near a corner of the screen can be more readily detected to correct the luminance level for preventing the burn-in in such a case.

It can be thought that the screen burn-in is likely to occur because the clock image is displayed at white level near the upper right corner of the screen as illustrated in FIG. 12(A). In such an event, the foregoing condition F is established, as illustrated in FIG. 12(B), so that the luminance level is corrected.

On the other hand, as illustrated in FIG. 13(A) as an example, when a displayed image gradually changes from a bright region on the left side of the screen to a dark region on the right side of the screen, it is thought that the screen burn-in is unlikely to occur. In such an event, as illustrated in FIG. 13(B), the condition F is not satisfied because not only the number of pixels at a particular luminance level of the luminance levels included in the white level but also the number of pixels at other luminance levels included in the white level are equal to or larger than the fifth threshold e, so that the luminance level is not corrected.

As described above, according to the second embodiment, the partial display area R is specified in one display screen, a luminance level distribution is detected for the display area R, and the luminance level is corrected in the display area R, thereby making it possible to reduce the burn-in caused, for example, by the displayed clock image or the displayed channel number image in a favorable manner.

The second embodiment has been described for an example in which the luminance level is corrected when only the number of pixels at a specific luminance level of luminance levels included in white levels is equal to or larger than the fifth threshold e, whereas the luminance is not corrected when not only the number of pixels at the specific luminance level but also the number of pixels at the remaining luminance levels included in white levels are equal to or larger than the fifth threshold e, as illustrated in FIG. 13. Alternatively, the luminance level may be simply corrected in any case if “the number of pixels at the particular luminance level is equal to or larger than the fifth threshold within the luminance levels included in the white level area,” so that the luminance level may be corrected not only in the case as illustrated in FIG. 12 but also in the case as illustrated in FIG. 13.

### Third Embodiment

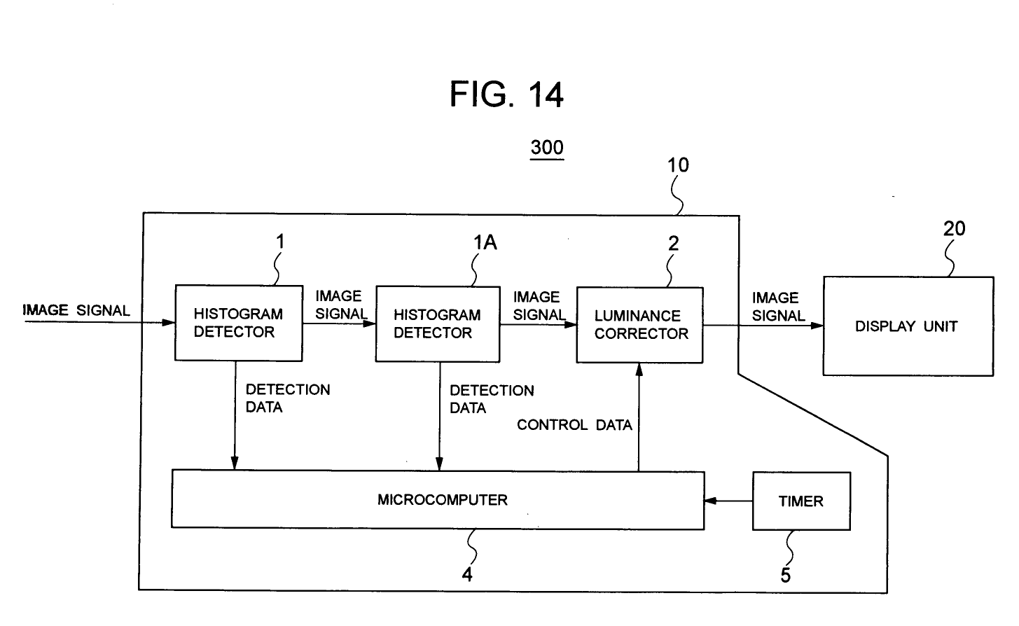

FIG. 14 is a block diagram illustrating the configuration of a display device 300 which is a third embodiment of the present invention.

While each of the foregoing embodiments has been described for an example in which the display device comprises only one histogram detector 1, the third embodiment will be described for the display device which comprises a plurality of histogram detectors 1, 1A, as illustrated in FIG. 14.

Since the display device 300 of the third embodiment is different from the display device 100 of the foregoing first embodiment only in the following respects, but is configured similarly to the display device 100 of the first embodiment in other respects, the components in the display device 300 of the third embodiment similar to those in the display device 100 have the same reference numerals and the descriptions thereof are omitted.

Specifically, in the third embodiment, a previous histogram detector (first luminance level distribution detecting means) 1 detects a luminance level distribution for the entirety of one display screen, while a subsequent histogram detector 1A (second luminance level distribution detecting means) detects a luminance level distribution for a partial display area R (see FIG. 12) of one display screen.

A microcomputer 4 transfers control data to a luminance corrector 2 to correct the luminance level when the luminance level distributions detected by any of the histogram detectors 1, 1A satisfy any of the aforementioned conditions (for example, conditions D, E, F).

As described above, according to the third embodiment, by employing two ICs (histogram detectors 1, 1A) capable of detecting histograms, information on each luminance level of a displayed image can also be acquired by simultaneously detecting a histogram associated with the part of the displayed image and a histogram associated with the entire displayed image.

While the third embodiment has been described for an example in which the display device comprises two histogram detectors 1, 1A, the present invention is not limited to the foregoing, but three or more histogram detectors may be provided to detect luminance level distributions for a plurality of display areas different from each other (where they may overlap with one another). Alternatively, a single histogram detector may detect luminance level distributions for a plurality of display areas different from each other.

### Fourth Embodiment

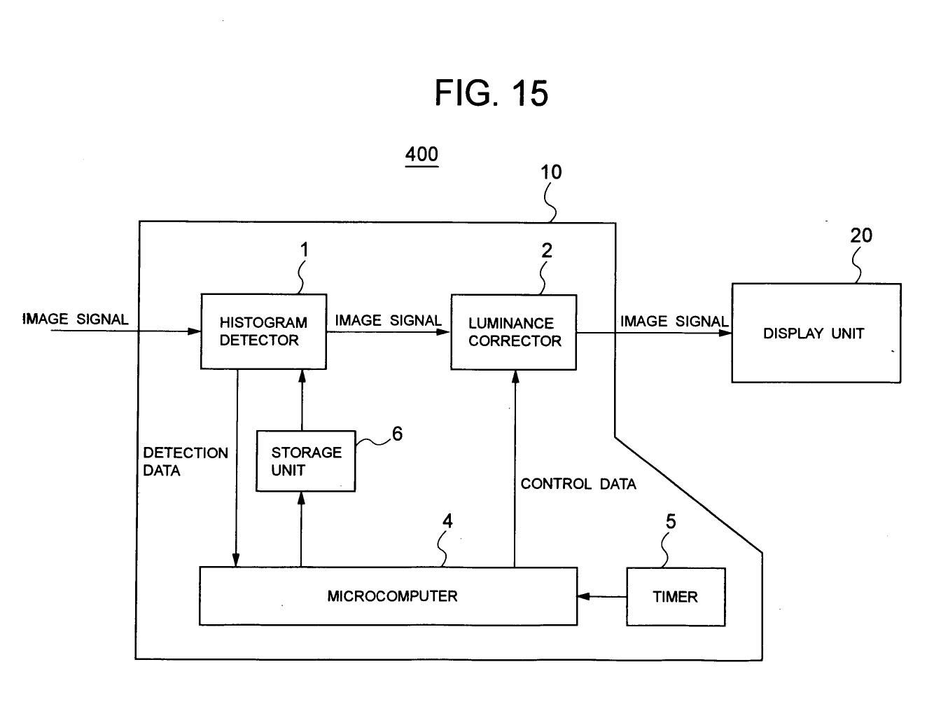

FIG. 15 is a block diagram illustrating the configuration of a display device 400 according to the fourth embodiment.

While each of the foregoing embodiments has been described for an example in which the histogram detector 1 detects a luminance level distribution only for a single predefined display area, a fourth embodiment will be described for an example in which display areas intended for detection of the statistic distribution are changed in sequence.

Since the display device 400 of the fourth embodiment is different from the display device 150 of the exemplary modification of the foregoing first embodiment (FIG. 11) only in the following respects, but is configured similarly to the display device 150 in other respects, the components in the display device 400 of the fourth embodiment similar to those in the display device 150 have the same reference numerals and the descriptions thereof are omitted.

Specifically, in the fourth embodiment, a display device 10 comprises a storage unit 6 for storing display area specifying data for specifying a display area for which a luminance level distribution is to be detected in an image, for example, as illustrated in FIG. 15, so that a histogram detector 1 reads the display area specifying data from the storage unit 6, and detects a luminance level distribution for a display area specified by the display area specifying data. Also, a microcomputer 4 sequentially re-writes the display area specifying data in the storage unit 6 to sequentially change display areas for which the histogram detector 1 detects a luminance level distribution.

In the fourth embodiment, the microcomputer 4 and storage unit 6 make up a detection area changing means, where the microcomputer 4 assumes a specifying data re-writing means, and the storage unit 6 assumes a storing means.

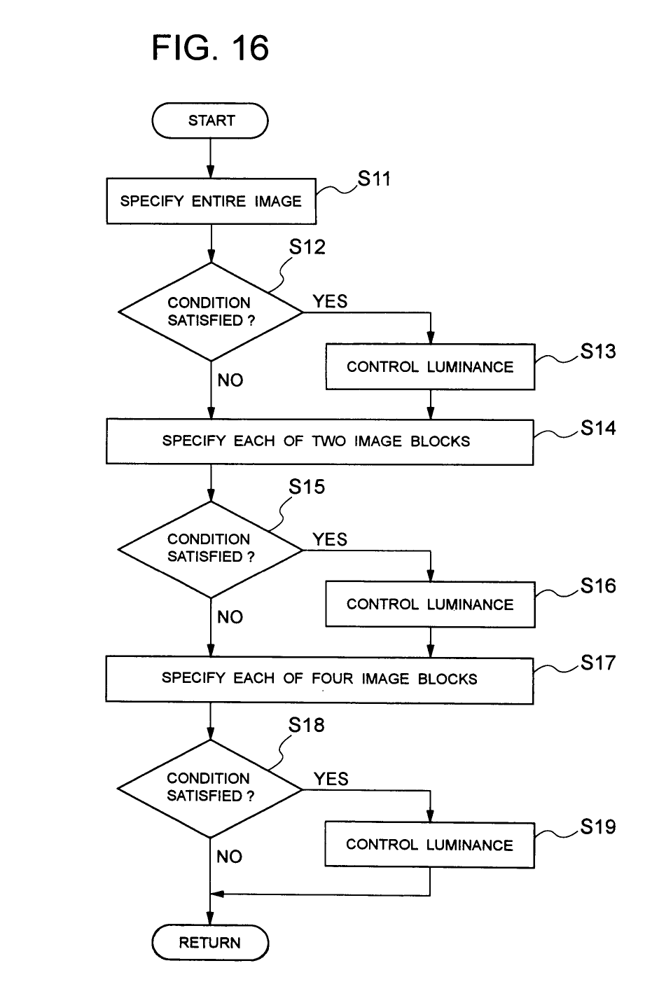

Next, the operation in the fourth embodiment will be described with reference to a flow chart of FIG. 16.

The microcomputer 4 first specifies, for example, the overall display screen as a display area intended for the detection of a luminance level distribution (step S11). Specifically, the microcomputer 4 sets the display area specifying data in the storage unit 6 to specify the overall display screen.

In response, the histogram detector 1 reads the display area specifying data from the storage unit 6, detects a luminance level distribution for the display area specified by the read display area specifying data, i.e., the overall display screen, and transfers the result of the detection to the microcomputer 4.

Then, the microcomputer 4 determines whether or not the luminance level distribution detected by the histogram detector 1 satisfies the condition G which defines that any of the aforementioned conditions (for example, the conditions D, E, F) is satisfied for the predetermined time a or longer (step S12).

When the microcomputer 4 determines that the luminance level distribution satisfies the condition G (YES at step S12), the microcomputer 4 transfers control data to the luminance corrector 2 to correct the luminance level (step S13).

On the other hand, when the microcomputer 4 determines at step S12 that the luminance level distribution does not satisfy the condition G (NO at step S12), or after the luminance level has been corrected (step S13), the microcomputer 4 rewrites the display area specifying data in the storage unit 6 to specify respective display areas bisected from the overall screen as display areas intended for the detection of luminance level distributions (step S14).

In response, the histogram detector 1 detects luminance level distributions for display areas specified by the display area specifying data, i.e., for the respective display areas bisected from the overall screen, and transfers the result of the detection to the microcomputer 4.

Then, the microcomputer 4 determines whether or not the luminance level distribution associated with any of the two divided display areas satisfies the aforementioned condition G (step S15).

When the microcomputer 4 determines that the luminance level distribution associated with any display area satisfies the condition G (YES at step S15), the microcomputer 4 transfers control data to the luminance corrector 2 to correct the luminance level in the display area, the luminance level distribution of which satisfies the condition G (step S16).

On the other hand, when the microcomputer 4 determines at step S15 that the luminance level distribution associated with any of the two divided display areas does not satisfy the condition G (NO at step S15), or after the luminance level has been corrected (step S16), the microcomputer 4 re-writes the display area specifying data in the storage unit 6 to specify four respective display areas divided from the overall screen as display areas intended for the detection of luminance level distributions (step S17).

In response, the histogram detector 1 detects a luminance level distribution for each of the four display areas divided from the overall screen, and transfers the result of the detection to the microcomputer 4.

Then, the microcomputer 4 determines whether or not the luminance level distribution associated with any of the four divided display areas satisfies the condition G (step S18), and transfers control data to the luminance corrector 2 when it satisfies the condition G (YES at step S18) to correct the luminance level in the display area, the luminance level distribution of which satisfies the condition G (step S19).

On the other hand, when the microcomputer 4 determines at step S18 that the luminance level distribution associated with any of the four divided display area does not satisfy the condition G (NO at step S18), or after the luminance level has been corrected (step S19), the microcomputer 4 returns the display area intended for the diction of a luminance level distribution to the overall screen (repetition from step S11).

Subsequently, the display area intended for the detection of the luminance level distribution is repeatedly set to the overall screen, the two respective display areas divided from the overall screen, and the four respective display areas divided from the overall screen in order.

As described above, according to the fourth embodiment, a display area intended for the detection of a luminance level distribution by the histogram detector 1 is changed in sequence, so that even if an image, which satisfies a condition under which the burn-in is likely to occur, is displayed in any display area of the display screen, this condition can be detected to correct the luminance.

While the fourth embodiment has been described for an example in which the step of detecting a luminance level distribution involves the step of detecting the luminance level distribution for the overall screen, the step of detecting the luminance level distribution for each of two display areas divided from the overall screen, and the step of detecting the luminance level distribution for each of four display areas divided from the overall screen, the step of detecting the luminance level distribution may further include the step of detecting the luminance level distribution for each of eight display areas divided from the overall screen, the step of detecting the luminance level distribution for each of 16 display areas divided from the overall screen, . . . , in sequence.

Also, the fourth embodiment has been described for an example in which the luminance level distribution detection is performed in parallel for a plurality of divided display areas (divided by two, four), the luminance level distribution may be detected in sequence for a plurality of divided display areas (divided by two, four), respectively. Specifically, when a first and a second divided display area are specified for the detection of the luminance level distribution, the luminance level distribution can be first detected for the first display area, followed by the detection of the luminance level distribution for the second display area.

Also, each of the foregoing embodiments has been described for an example in which the luminance level distribution is detected as a histogram representation, but in essence, any statistical distribution with respect to luminance levels may only have to be recognized, so that the luminance level distribution may be represented in another statistical graph.

### Fifth Embodiment

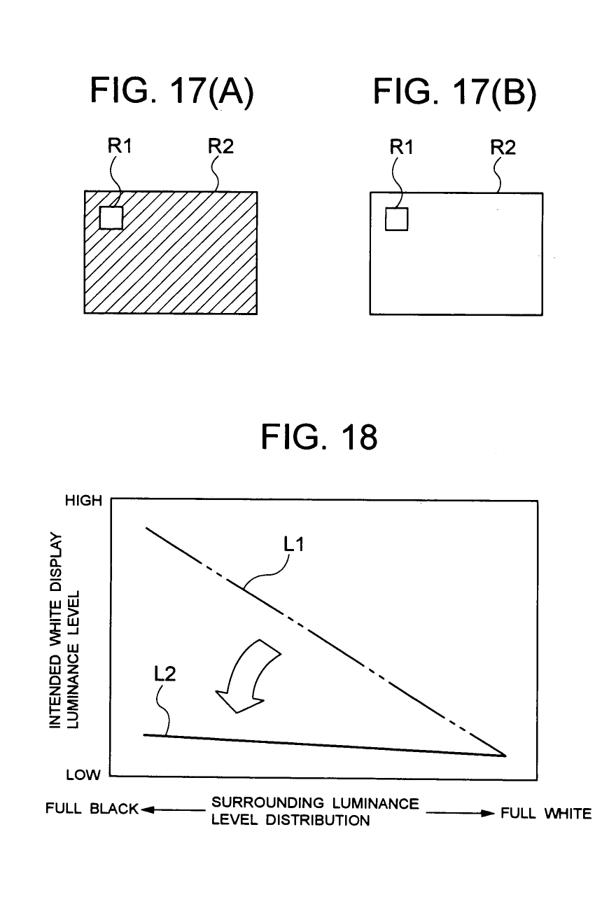

FIG. 17 and FIG. 18 include diagrams illustrating correction made by a luminance corrector 2 in the fifth embodiment, wherein FIG. 17(A) illustrates a screen display where a display area R1 at a white level is surrounded by a display area R2 entirely in black (the luminance gradation level of all the pixels in the display area R2 is at 0), and FIG. 17(B) illustrates a screen display where a display area R1 at a white level is surrounded by a display area R2 entirely in white (the luminance gradation level of all the pixels in the display area R2 is at 255). FIG. 18 illustrates an exemplary correction curve (curved line L2) used for the luminance level correction in the fifth embodiment.

Each of the foregoing embodiments has been described for an example in which as the correction by the luminance corrector 2 at a time when the microcomputer 4 determines that correction is required, for example, the luminance level of pixels at white level or particular pixels out of the pixels at white level is reduced by a prescribed ratio (for example, reduced to 70% or 50%, or reduced by 30% or 50%) independently of the distribution mode of the luminance level of the surrounding pixels.

Generally, however, pixels at white level are controlled so as to be displayed at a higher luminance as the luminance level distribution of the surrounding pixels becomes closer to full black (Average Picture Level (APL) is low) whereas at a lower luminance as closer to full white (APL is high). This is because, unless luminance is corrected in such a manner, on a dark screen where APL of an image signal becomes lower, the contrast ratio decreases, and the display image quality degrades. Also, for display devices (for example, PDP), since the difference in power consumption between high and low APLs is large, there is a problem in that a burden loaded on a power source becomes heavier.

In order to solve such problems, for example, comparing the case in which the display area surrounding the white level display area R1 is full black as illustrated in FIG. 17(A) with the case in which the display area R2 surrounding the white level display area R1 is full white as illustrated in FIG. 17(B), the former is normally controlled so as to be displayed at a higher luminance although both cases are displayed at the same white level.

Specifically, normally, for example, the luminance level of pixels at white level is controlled according to a curved line L1 illustrated in FIG. 18.

However, such a control is likely to cause screen burn-in, for example, in the luminance level distribution state illustrated in FIG. 17(A) or a luminance level distribution state similar to this.

Accordingly, in the fifth embodiment, as the correction by the luminance corrector 2 at a time when the microcomputer 4 determines that correction is required, the luminance level of pixels at white level is reduced by a higher ratio as the luminance level distribution of the surrounding pixels becomes lower.

That is, the luminance corrector 2, specifically, makes a correction so as to control the luminance level of pixels at white level according to a curved line L2 illustrated in FIG. 18, for example, under the control of the microcomputer 4.

As a result, as illustrated in FIG. 17(A) for example, screen burn-in can be prevented from occurring even in the luminance level distribution state in which the display area R2 surrounding the white level display area R1 is full black or a luminance level distribution state similar to this.

According to the above fifth embodiment, since the luminance corrector 2 corrects the luminance level of pixels intended for correction by reducing the luminance level by a higher ratio as the luminance level of the surrounding pixels becomes lower, burn-in can be reduced in a more favorable manner than in each of the foregoing embodiments.

### Sixth Embodiment

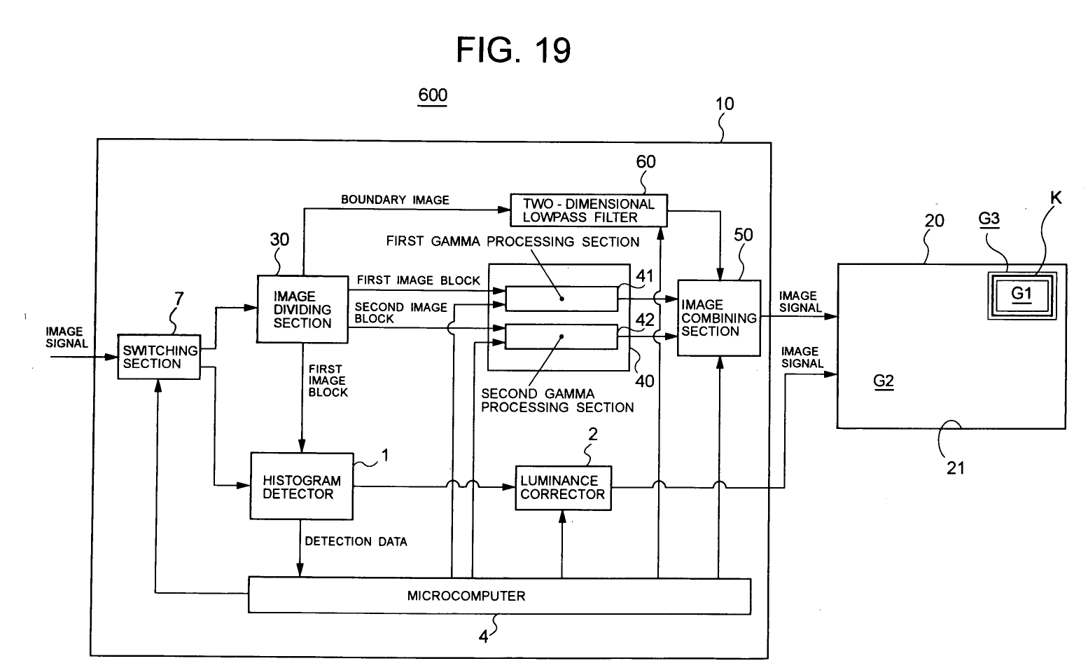

FIG. 19 is a block diagram illustrating the configuration of a display device 600 which is a sixth embodiment of the present invention.

Since the display device 600 illustrated in FIG. 19 is different from the display device 100 according to the foregoing first embodiment only in the following respects to be described, but is configured similarly to the display device 100 in other respects, the components in the display device 600 similar to those in the display device 100 have the same reference numbers and the descriptions thereof are omitted.

While each of the foregoing embodiments has been described for an example in which the luminance level of an image signal is corrected, the display device 600 of the sixth embodiment alternatively either corrects the luminance level of an image signal or performs nonlinear processing on an image signal.

In order to achieve such an operation, a burn-in reduction unit 10 of the display device 600, as illustrated in FIG. 19, in addition to each of the components of the burn-in reduction unit 10 in the display device 100 of the foregoing first embodiment, further comprises an image dividing section (image dividing means) 30 for dividing an image into a plurality of blocks, a gamma processing section (nonlinear processing means) 40 for applying gamma processing as an exemplary nonlinear processing on each of the image blocks separately, an image combining section (image combining means) 50 for combining the images after gamma processing, a two-dimensional lowpass filter (boundary image processing means) 60 for smoothing the boundary area between the image blocks to be combined, and a switching section 7 for switching between a first operation mode and a second operation mode. The first operation mode is a mode in which the image signal corrected by the luminance corrector 2 for the luminance level is supplied for display. The second operation mode is a mode in which the image signal image processed by the image dividing section 30, the gamma processing section 40, the two-dimensional lowpass filter 60 and the image combining section 50 is output for display.

Among these, the switching section 7 switches to either of the first operation mode and the second operation mode, for example, under the control of the microcomputer 4. The microcomputer 4, for example, outputs a control signal to the switching section 7 in accordance with a user's operation for an operating unit (not shown) so that the relevant switching section 7 switches to the first operation mode or the second operation mode. Specifically, the microcomputer 4 and the switching section 7 make up operation mode selecting means.

The input image signal to the burn-in reduction unit 10 is input to the switching section 7. The switching section 7 outputs the input image signal to a histogram detector 1 when the operation mode is switched to the first operation mode whereas it outputs the input image signal to the image dividing section 30 when the operation mode is switched to the second operation mode.

In this embodiment, the microcomputer 4 operates in the first operation mode similarly as in the foregoing first embodiment.

On the other hand, in the second operation mode, the microcomputer 4 controls the operations of the gamma processing section 40, the image combining section 50 and the two-dimensional lowpass filter 60 based on the data on the statistical distribution detected by the histogram detector 1.

Hereinafter, each of the components which function in the second operation mode will be described in further detail.

The image dividing section 30 divides the image to be displayed of one image signal input through the selecting section 7 into a plurality of image blocks.

In this embodiment, specifically, the image dividing section divides an image into two blocks, for example, a first image block G1 and a second image block G2.

In this embodiment, for example, the mutual borderline K between the first and second image blocks G1, G2 is preliminarily set, and the image dividing section 30 is configured so as to divide originally one image into the two first and second image blocks with the preset borderline K as a boundary. The borderline K, for example, may be rectangular as illustrated in FIG. 19.

Here, for example, the clock image on a television image is often displayed almost at the same position (display area) regardless of the selected channel.

Accordingly, in this embodiment, the image dividing section 30, specifically, for example, divides an image into two image blocks, one of the two image blocks (first image block G1) being in the display area where the clock is likely to be displayed on the display screen 21 of the display unit 20 (for example, upper right portion of the screen), and the other of the two image blocks (second image block G2) being in the rest of the display area.

The image dividing section 30 then supplies an image signal corresponding to one of the image blocks (first image block G1) to a first gamma processing section 41 (to be described later) and the histogram detector 1, respectively.

Also, the image dividing section 30 supplies an image signal corresponding to the other of the image blocks (second image block G2) to a second gamma processing section 42 (to be described later).

In addition, the image dividing section 30 supplies an image signal corresponding to an image in the mutual boundary area between the two image blocks (boundary image G3) to the two-dimensional lowpass filter 60.

Here, the boundary image G3 is an image of a specified area including the borderline K between the first image block G1 and the second image block G2, and for example, an image of the area sandwiched by two rectangles which are similar to each other and whose centers are equal to each other as indicated by hatching in FIG. 19.

The gamma processing section 40 comprises the first gamma processing section 41 for performing gamma processing on the image signal corresponding to the first image block G1 and the second gamma processing section 42 for performing gamma processing on the image signal corresponding to the second image block G2.

The first gamma processing section 41 and the second gamma processing section 42 select a gamma curve and perform gamma processing on an image signal under the control of the microcomputer 4, respectively and independently.

Specifically, for example, as will be described later, when it is determined that screen burn-in is likely to occur in the display area of the first image block G1 based on the result detected by the histogram detector 1, the microcomputer 4 supplies a control signal to the first gamma processing section 41 and the second gamma processing section 42 so that the first gamma processing section 41 and the second gamma processing section 42 select a gamma curve which prevents screen burn-in.

The first gamma processing section 41 and the second gamma processing section 42 select one gamma curve which is the most suitable from a plural kinds of gamma curves preliminarily set as candidates for selection and apply gamma processing to an image signal respectively.

The first and second gamma processing sections 41, 42 supply an image signal to which gamma processing is applied, to the image combining section 50, respectively.

Also, the two-dimensional lowpass filter 60 performs processing (smoothing processing) for smoothing the display area (range) specified by the microcomputer 4 out of the image of the boundary area between the first image block G1 and the second image block G2, specifically, the boundary image G3 so as to make the relevant image inconspicuous by scumbling.

Specifically, the two-dimensional lowpass filter 60, in each pixel included in the image of the display area specified by the microcomputer 4 out of the boundary image G3, makes the relevant image unsharpened by gradually changing the display color and display luminance in the display position extending from an area close to the first image block G1 over an area close to the second image block G2.

More specifically, for example, when the first image block G1 is displayed whitishly at a high luminance (due to a displayed clock or the like) and the second image block G2 is displayed darkly at a low luminance, the two-dimensional lowpass filter 60 performs filter processing so that the image gradually changes to be brighter at a higher luminance as the image becomes closer to the first image block G1 side from the second image block G2 side.

The two-dimensional lowpass filter 60 outputs such an image signal after smoothing processing to the image combining section 50.

The image combining section 50 combines the image signals supplied from the first gamma processing section 41, the second gamma processing section 42 and the two-dimensional lowpass filter 60 into one image signal.

Here, the first image block G1 has an area which mutually overlaps with the boundary image G3 (portion overlapping with the entire boundary image G3), and similarly, the second image block G2 also has a portion which mutually overlaps with the boundary image G3 (also, portion overlapping with the entire boundary image G3).

Accordingly, the image combining section 50, for the overlapped portions, overwrites the image signals supplied from the first and second gamma processing sections 41, 42 (first image block G1, second image block G2) by the image signal supplied from the two-dimensional lowpass filter 60 (boundary image G3), respectively. Specifically, each of the overlapped portions in the first image block G1 and the second image block G2 is replaced by the boundary image G3 respectively.

Also, here, the microcomputer 4 determines whether or not the smoothing processing result by the two-dimensional lowpass filter 60 should be reflected on the image in accordance with the result detected by the histogram detector 1, and supplies a command signal for commanding whether or not the smoothing processing result should be reflected on the image to the image combining section 50.

Specifically, for example, when determining that no screen burn-in can occur based on the detection result by the histogram detector 1, the microcomputer 4 supplies a command signal such that the smoothing processing result by the two-dimensional lowpass filter 60 will not be reflected on the image to the image combining section 50. In this event, the image combining section 50, without combining the image signal supplied from the two-dimensional lowpass filter 60 (boundary image G3), combines only the image signals supplied from the first and second gamma processing sections 41, 42 (first image block G1, second image block G2).

On the other hand, when determining that screen burn-in can occur based on the detection result by the histogram detector 1, the microcomputer 4 supplies a command signal such that the smoothing processing result by the two-dimensional lowpass filter 60 should be reflected on the image to the image combining section 50. In this event, the image combining section 50 combines three image signals supplied from the first gamma processing section 41, the second gamma processing section 42 and the two-dimensional lowpass filter 60 into one image signal.

Next, the histogram detector 1 detects, in the second operation mode of this embodiment, for example, a statistical distribution with respect to luminance levels (hereinafter called the “luminance level distribution”) of pixels included in the first image block G1.

The detection operation by the histogram detector 1 is similar to that in each of the foregoing embodiments.

The histogram detector 1 supplies the luminance level distribution data (luminance level distribution data) detected in such a manner to the microcomputer 4.

The microcomputer 4 determines whether or not burn-in can occur on the screen in the display area of the first image block G1 in accordance with the luminance level distribution data from the histogram detector 1.

Also in this embodiment, the determination operation by the microcomputer 4 is similar to the determination operation by the microcomputer 4 in each of the foregoing embodiments.

Also, in the second operation mode of this embodiment, when the microcomputer 4 determines that screen burn-in can occur by such a determination operation, control data is supplied to the first gamma processing section 41, the second gamma processing section 42, the two-dimensional lowpass filter 60 and the image combining section 50 respectively so as to reduce burn-in.

Specifically, when determining that screen burn-in can occur, the microcomputer 4 makes the first gamma processing section 41 select a gamma curve such that the light/dark difference between each pixel in the image is reduced, so as to reduce burn-in. Specifically, the gamma curve used for gamma processing is changed from the gamma curve which has been selected (for example, a standard gamma curve) to another gamma curve.

For the second gamma processing section 42, for example, the microcomputer 4 may have the second gamma processing section 42 select a standard gamma curve, or select a gamma curve which brings the brightness of the second image block G2 closer to the brightness of the first image block G1. Specifically, the difference between the luminance level distributions of the second image block G2 and the first image block G1 may be reduced.

Also, the microcomputer 4 supplies a signal for specifying the range of the boundary image G3 to which smoothing processing is to be applied, to the two-dimensional lowpass filter 60. Here, for example, the microcomputer 4 supplies a signal for commanding that the range of the boundary image G3 to which smoothing processing is to be applied should be expanded when determining that the first image block G1 is extremely bright based on the detection result by the histogram detector 1 whereas it supplies a signal for commanding that the range of the boundary image G3 to which smoothing processing is to be applied should be narrowed when determining the first image block G1 is relatively dark although screen burn-in is likely to occur.

Further, the microcomputer 4 gives a command to the image combining section 50 that the smoothing processing result by the two-dimensional lowpass filter 60 should be reflected on the image.

Accordingly, when the screen burn-in can occur, the image where the image burn-in in the display area of the first image block G1 is reduced and where smoothing processing is applied to the boundary area between the first image block G1 and the second image block G2 (boundary image G3) is displayed on the display screen 21.

On the other hand, when determining that no screen burn-in can occur by the foregoing determination, the microcomputer 4 supplies command signals to the first and second gamma processing sections 41, 42 for commanding that both should perform gamma processing using a standard gamma curve and to the image combining section 50 for commanding that the smoothing processing result by the two-dimensional lowpass filter 60 should not be reflected on the image.

Accordingly, when no screen burn-in can occur, gamma processing is applied to both first and second image blocks G1, G2 by a standard gamma curve for display, and without combining the boundary image G3 smoothing processed by the two-dimensional lowpass filter 60, only the first and second image blocks G1, G2 are combined and displayed.

According to the above sixth embodiment, the burn-in reduction unit 10 comprises the switching section 7 for switching between the first operation mode and the second operation mode; the image dividing section 30 for dividing an image to be displayed of one input image signal into two blocks in the second operation mode; the image combining section 50 for combining the divided two images by the image dividing section 30 into one in the second operation mode; and the gamma processing section 40 for applying gamma processing to each of the two image blocks obtained by the image dividing section 30 respectively and separately before the combination of the image blocks by the image combining section 50 in the second operation mode. Thus, when a part of the image to be displayed of one input image signal (first image block G1) is likely to cause screen burn-in in the second operation mode, gamma processing can be applied only to the part of the image so that the light/dark difference of the relevant image will be reduced, whereas gamma processing can be applied to the rest of the image (second image block G2) so as to be displayed with normal brightness. Therefore, for example, burn-in on a display screen can be favorably reduced.

Since functioning similarly as in the foregoing first embodiment, the burn-in reduction unit 10 achieves the same effects in the first operation mode as in the first embodiment.

Here, although an image display at high luminance consumes much electric power, when an image is likely to cause screen burn-in as described above, by applying gamma processing such that the light/dark difference in the image will be reduced so as to reduce the luminance of the display image with the result that power consumption can also be reduced.

Furthermore, the histogram detector 1 of the burn-in reduction unit 10 detects the statistical distribution with respect to luminance levels of pixels included in one image (first image block G1) of the image blocks obtained by the mage dividing section 30. The gamma processing section 40 applies gamma processing to an image in accordance with the statistical distribution detected by the histogram detector 1. Thus, the most suitable gamma processing can be performed on each of the image blocks respectively and automatically.

More specifically, the histogram detector 1 detects a statistical distribution of the number of pixels with respect to luminance levels, the microcomputer 4 determines whether or not screen burn-in can occur based on the relevant detected statistical distribution, and the gamma processing section 40 applies gamma processing to an image in accordance with the relevant determination result. Thus, the most suitable gamma processing can be performed on each of the image blocks respectively and automatically.

Further, since the burn-in reduction unit 10 comprises the two-dimensional lowpass filter 60 for performing smoothing processing on the image in the mutual boundary area between a plurality of the image blocks obtained by the image dividing means (boundary image G3), the boundary image G3 can be unsharpened. Therefore, since the prominence of the boundary image G3 can be prevented, and the first image block G1 and the second image block G2 can be jointed smoothly with the result that the screen burn-in in the display area of the boundary image G3 can be reduced favorably.

Also, for the boundary image G3, smoothing processing can be applied to the appropriate range of the image to which smoothing processing is to be applied by expanding or narrowing the range of the image, and for example, image quality degradation due to too wide range smoothing processing or image borderline prominence due to too narrow range smoothing processing can be prevented.

Further, since the control whether or not a smoothing processing result should be reflected on a display image can be conducted, the relevant result can be reflected on the display image only when smoothing processing is required.

While the foregoing sixth embodiment has been described for an example in which the configuration of the foregoing first embodiment is partially changed, a similar change can be applied to any of the foregoing second to fifth embodiments.

While the foregoing sixth embodiment has been described for an example in which the most suitable gamma processing is applied to each of the image blocks obtained by the image dividing section 30 in the gamma processing section 40 separately and respectively, the most suitable gamma processing may be applied to at least any one of the image blocks obtained by the image dividing section 30 in the gamma processing section 40. Specifically, for example, when a standard gamma processing has already been applied to the original image signal collectively before input into the burn-in reduction unit 10, for example, a specific gamma processing may be applied only to the first image block G1 in the gamma processing section 40 so as to reduce screen burn-in.

While the foregoing sixth embodiment has been described for an example in which the first image block G1 is set at the upper right area on the display screen 21, the area setting of the first image block G1 may be changed arbitrarily for each purpose. Specifically, while the first image block G1 is set at the upper right area on the display screen 21 so as to detect the presence or absence of a displayed clock, a displayed channel or the like in the first embodiment, for example, when detecting the presence or absence of subtitles for a movie, the first image block G1 may be set at the lower area on the display screen 21. Also, while the foregoing sixth embodiment has been described for an example in which the borderline K1 is set as a rectangle, the shape of the relevant borderline K1 may be changed arbitrarily for each purpose.

Further, the foregoing sixth embodiment has been described for an example in which when determining that burn-in will occur, for combining each image in the image combining section 50, the first image block G1 and the second image block G2 are overwritten by the third image block G3 respectively. However, for the overlapped portion of the first image block G1 and the third image block G3, the image obtained by averaging both images G1, G3 may be displayed, and similarly, for the overlapped portion of the second image block G2 and the third image block G3, the image obtained by averaging both images G2, G3 may be displayed.

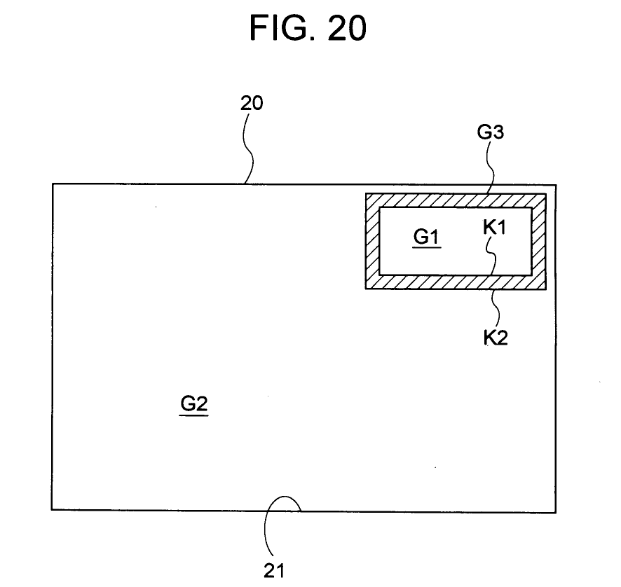

Alternatively, while the foregoing sixth embodiment has been described for an example in which the first image block G1 and the second image block G2 have a portion which mutually overlaps with the boundary image G3 respectively, division is preferably carried out in such a manner that the first image block G1, the second image block G2 and the boundary image G3 have no overlapped portion. Specifically, as illustrated in FIG. 20, of borderlines K1, K2 of two rectangles which are similar to each other and whose centers are equal to each other, the inner borderline K1 separates the first image block G1 from the boundary image G3 whereas the outer borderline K2 separates the second image block G2 from the boundary image G3, and an image of the area sandwiched by the borderlines K1, K2 may become the boundary image G3.

Also, while the foregoing sixth embodiment has been described for an example in which the range of the boundary image G3 to which smoothing processing is to be applied is expanded or narrowed in accordance with the detection result by the histogram detector 1, the range to which smoothing processing is to be applied may be fixed (for example, the entire boundary image G3 with no change).

Also, the foregoing sixth embodiment has been described for an example in which whether or not the smoothing processing result by the two-dimensional lowpass filter 60 should be reflected on an image is controlled by giving a command to the image combining section 50 whether or not the smoothing processing result should be reflected on the image. However, whether or not the smoothing processing result should be reflected on the image may be controlled by giving the command to the two-dimensional lowpass filter 60 instead of the command to the image combining section 50. Specifically, when the detection result by the histogram detector 1 shows that screen burn-in can occur in the display area of the first image block G1, the microcomputer 4 may supply a control signal to the two-dimensional lowpass filter 60 so that the two-dimensional lowpass filter 60 will perform smoothing processing on the boundary image G3. On the other hand, when the detection result shows that no screen burn-in can occur in the display area of the first image block G1, the microcomputer 4 may supply a control signal to the two-dimensional lowpass filter 60 so that the two-dimensional lowpass filter 60 will not perform smoothing processing on the boundary image G3.

### Seventh Embodiment

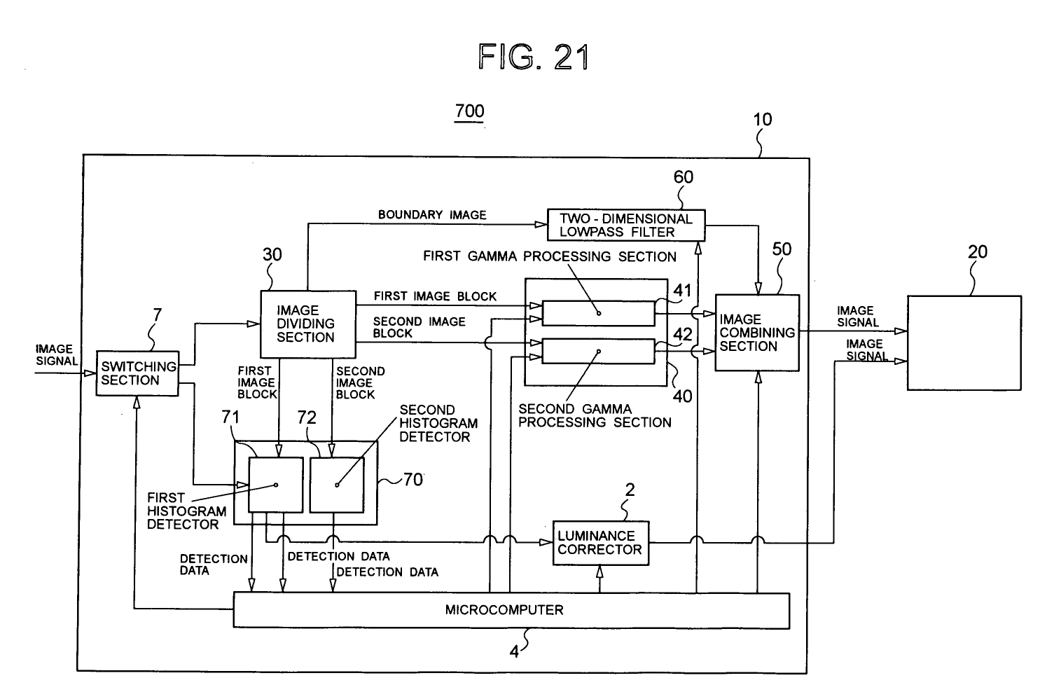

FIG. 21 is a block diagram illustrating the configuration of a display device 700 which is a seventh embodiment of the present invention.

While the foregoing sixth embodiment has been described for an example in which the histogram detector 1 detects a statistical distribution of pixels included in an image according to luminance levels only for the first image block G1 in the second operation mode, the seventh embodiment will describe for an example in which a histogram detector 70 detects a luminance level distribution for each of the first and second image blocks G1, G2 separately in the second operation mode.

Since the display device 700 of the seventh embodiment is different from the display device 600 of the foregoing sixth embodiment only in the following respects to be described, but is configured similarly to the display device 600 of the sixth embodiment in other respects, the components in the display device 700 of the seventh embodiment similar to those in the display device 600 have the same reference numerals and the descriptions thereof are omitted.

As illustrated in FIG. 21, in this embodiment, the display device 700 comprises a histogram detector 70 instead of the histogram detector 1. The histogram detector 70 comprises a first histogram detector 71 and a second histogram detector 72.

Among these, the first histogram detector 71 functions similarly to the histogram detector 1 in each of the foregoing embodiments in the first operation mode.

In this embodiment, a switching section 7 supplies an input image signal to the first histogram detector 71 when the operation mode is switched to the first operation mode whereas it supplies an input image signal to the image dividing section 30 when the operation mode is switched to the second operation mode.

In the second operation mode of this embodiment, the image dividing section 30 supplies an image signal corresponding to a first image block G1 to the first histogram detector 71 whereas it supplies an image signal corresponding to a second image block G2 to the second histogram detector 72.

Then, the first histogram detector 71 detects a luminance level distribution for the first image block G1 whereas the second histogram detector 72 detects a luminance level distribution for the second image block G2.

In the second operation mode of this embodiment, the microcomputer 4 conducts, for example, the following controls to be described.

First, the microcomputer 4, for the first and second image blocks G1, G2, for example, determines whether or not screen burn-in can occur and determines whether or not the images are too dark, respectively.

Specifically, the microcomputer 4, based on the detection data from the first histogram detector 72, similarly to the description in the foregoing sixth embodiment, in addition to determining whether or not screen burn-in can occur in the first image block G1, determines whether or not the first image block G1 is too dark based on the relevant detection data.

Similarly, the microcomputer 4, based on the detection data from the second histogram detector 72, in addition to determining whether or not screen burn-in can occur in the second image block G2, determines whether or not the second image block G2 is too dark.

Further, the microcomputer 4 determines whether or not the light/dark difference between the first image block G1 and the second image block G2 is too large.

Then, when determining that screen burn-in can occur in the first image block G1, the microcomputer 4 outputs control data to a first gamma processing section 41 so that the first gamma processing section 41 selects a gamma curve such that the light/dark difference between pixels in the first image block G1 is reduced, thereby reducing burn-in.

Similarly, when determining that screen burn-in can occur in the second image block G2, the microcomputer 4 supplies control data to the second gamma processing section 42 so that the second gamma processing section 42 selects a gamma curve such that the light/dark difference between each pixel in the second image block G2 is reduced, thereby reducing burn-in.

When determining that the first image block G1 is too dark, the microcomputer 4 outputs control data to the first gamma processing section 41 so that the first gamma processing section 41 will select a gamma curve such that the gradation value in the first image block G1 is increased so as to improve the image quality of the first image block G1.

Similarly, when determining that the second image block G2 is too dark, the microcomputer 4 outputs control data to the second gamma processing section 42 so that the second gamma processing section 42 will select a gamma curve such that the gradation value in the second image block G2 is increased so as to improve the image quality of the second image block G2.

When determining that the light/dark difference between the first image block G1 and the second image block G2 is too large, the microcomputer 4 supplies control data to the first and second gamma processing sections 41, 42 respectively so that the light/dark difference of both images G1, G2 will be reduced, and makes the first and second gamma processing sections 41, 42 select a gamma curve such that the light/dark difference between the first image block G1 and the second image block G2 is reduced so as to improve the image quality of the entire display screen 21.

When determining that screen burn-in can occur in either of the first and second image blocks G1, G2, determining that either of the first and second image blocks G1, G2 is too dark or determining that the light/dark difference between the first and second image blocks G1, G2 is too large, the microcomputer 4 commands the image combining section 50 that the smoothing processing result by the two-dimensional lowpass filter 60 should be reflected on the image.

In this regard, when determining that the light/dark difference between the first image block G1 and the second image block is large based on the detection result by the histogram detector 70, the microcomputer 4, for example, supplies a signal for commanding that the range of the boundary image G3 on which smoothing processing is to be applied should be expanded to the two-dimensional lowpass filter 60. On the other hand, when determining that screen burn-in can occur in either of the first and second image blocks G1, G2, or that the light/dark difference between the first image block G1 and the second image block is small although either of the first and second image blocks G1, G2 is too dark, the microcomputer 4 supplies a signal for commanding that the range of the boundary image G3 on which smoothing processing is to be applied should be narrowed to the two-dimensional lowpass filter 60.

According to the above seventh embodiment, in addition to the similar effects as in the foregoing sixth embodiment, the following effects can be achieved.

In the second operation mode, since the first image block G1 and the second image block G2 are separately determined (for example, it is determined whether or not screen burn-in can occur, determined whether or not the image is too dark, or determined whether or not the light/dark difference is too large when the image seen on the whole), gamma processing is separately applied to the first image block G1 and the second image block G2 in accordance with the determination result, gamma processing can be applied to each of the images G1, G2 more favorably than in the sixth embodiment.

Specifically, for example, for each display area of the first and second image blocks G1, G2, screen burn-in can be reduced separately, the image quality of a dark image can be improved separately, or the image quality of the entire display screen 21 can be improved by reducing the difference in image quality of each display area of the first and second image blocks G1, G2 (determined based on luminance level distribution difference).

While the foregoing seventh embodiment has been described for an example in which the image dividing section 30 divides an image into two blocks, may divide into three or more blocks. In this configuration, for example, when the division number of an image is defined as n (=3 or more), the gamma processing section 40 comprises at least (n−1) or n number of gamma processing sections and the histogram detector 70, also comprises at least (n−1) or n number of histogram detectors. The gamma processing section 40 may detect at least (n−1) or n number of images out of the images divided into n number for luminance level distribution respectively and separately, and gamma processing may be applied respectively and separately in accordance with the relevant detected luminance level distribution.

### Eighth Embodiment

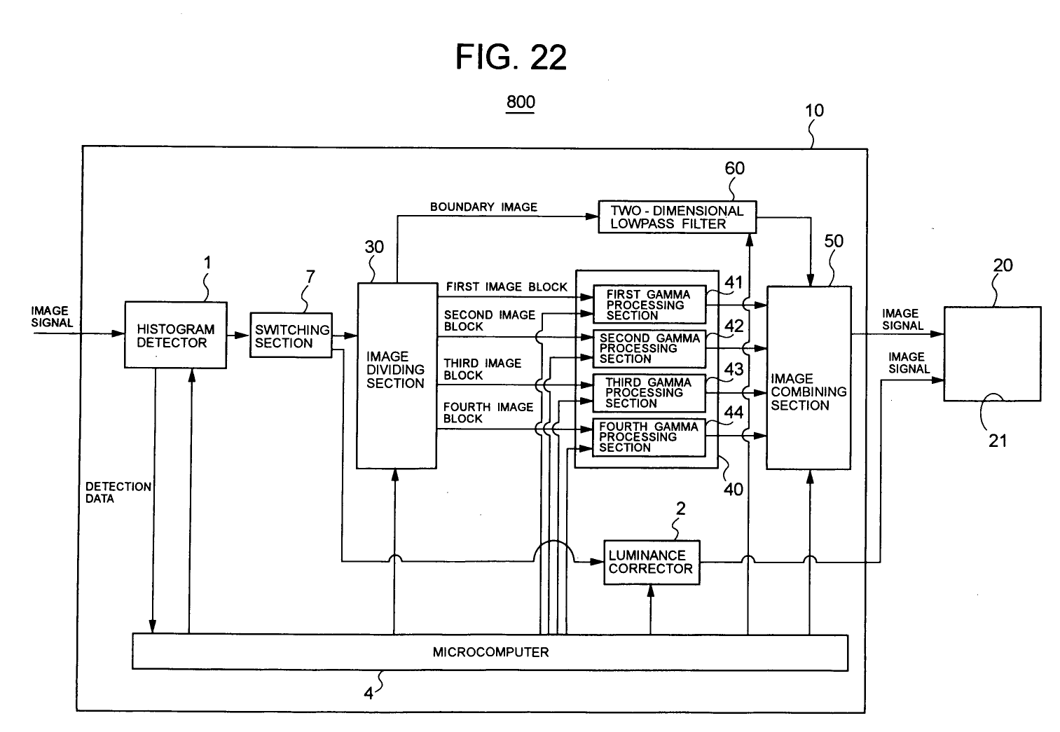

FIG. 22 is a block diagram illustrating the configuration of a display device 800 which is an eighth embodiment of the present invention.

While the foregoing sixth and seventh embodiments have been described for examples in which the division boundary is set preliminary for dividing an image in the image dividing section 30, the eighth embodiment will be described for an example in which the division boundary of an image is determined based on the luminance level distribution detected by the histogram detector 1.

Since the display device 800 of the eighth embodiment is different from the display device 600 of the foregoing sixth embodiment only in the following respects to be described, but is configured similarly to the display device 600 of the sixth embodiment, the components in the display device 800 of the eighth embodiment similar to those in the display device 600 have the same reference numerals and the descriptions thereof are omitted.

As illustrated in FIG. 22, in this embodiment, a histogram detector 1, for example, is provided at a front stage to an image dividing section 30 and a switching section 7.

In the second operation mode, an image signal is input to the image dividing section 30 through the histogram detector 1 and the switching section 7.

On the other hand, in the first operation mode, an image signal is input to a luminance corrector 2 through the histogram detector 1 and the switching section 7.

A gamma processing section 40, for example, comprises first to fourth gamma processing sections 41, 42, 43, 44.

In the second operation mode of this embodiment, the histogram detector 1 is configured so that the two kinds of detection operations given below are available, for example.

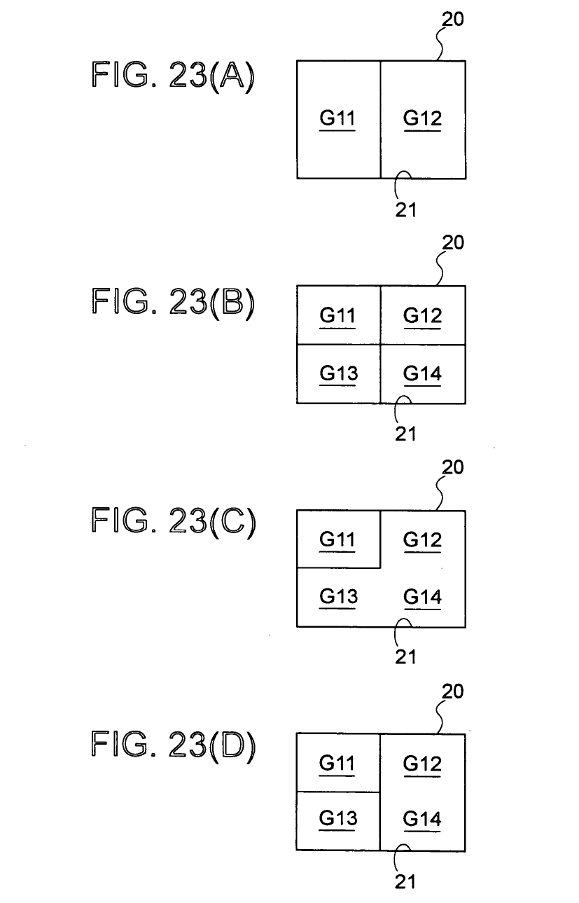

(1-1) Operation for respectively detecting a luminance level distribution of the image displayed in each display area obtained by dividing a display screen 21 into two (first and second divided images G11, G12 in FIG. 23(A)).

(1-2) Operation for respectively detecting a luminance level distribution of the image displayed in each display area obtained by dividing the display screen 21 into four (first to fourth image blocks G11-G14 in FIG. 23(B)).

Further, the microcomputer 4 conducts determination operations as given below so as to control a gamma controlling unit 40, the two-dimensional lowpass filter 60 and an image combining section 50 in accordance with the determination result.

(2-1) Based on the result of the foregoing (1-1) detection operation by the histogram detector 1, when determining that either of a first image block G11 and the second image block G12 in FIG. 23(A) is too dark or can cause screen burn-in, or when determining the light/dark difference between both images G11, G12 is problematically too large, the microcomputer 4 determines that the first and second image blocks G11, G12 should be divided. Specifically, in this event, the microcomputer 4 determines that the image on the display screen 21 should be divided into two, for example, in such a manner as illustrated in FIG. 23(A).

In this event, the microcomputer 4 commands that the image dividing section 30 should divide the image on the display screen 21 into the first image block G11 and the second image block G12 of FIG. 23(A) and should supply an image signal corresponding to each of the relevant image blocks to the first and second gamma processing sections 41, 42. The microcomputer 4 also commands that the image of the mutual boundary area between the relevant first and second divided portion images Gil, G12 (for example, the image adjacent to the linear borderline illustrated in FIG. 23(A)) should be supplied to the two-dimensional lowpass filter 60.

The microcomputer 4 commands that the two-dimensional lowpass filter 60 should expand or narrow the range of smoothing processing in accordance with types and degrees of the problems in the images G11, G12.

The microcomputer 4 commands that the image combining section 50 should combine the images G11, G12 and their boundary image.

(2-2) When determining that the first and second image blocks G11, G12 should not be divided based on the result of the foregoing (1-1) detection operation by the histogram detector 1, if determining that only any one of the first to fourth image blocks G11-G14 is too dark or can cause screen burn-in based on the result of the foregoing (1-2) detection operation by the histogram detector 1 or if determining that the light/dark difference between only any one image and the other images is too large, the microcomputer 4 determines that only the relevant one image of the images on the entire display screen 21 (any one of the first to fourth image blocks G11-G14 in FIG. 23(B)) should be divided. Specifically, in this event, the microcomputer 4 determines that the image on the display screen 21 should be divided into two, for example, in such a manner as illustrated in FIG. 23(C).

In this event, the microcomputer 4 makes the image dividing section 30 divide only any one problematic image of the images on the entire display screen 21 (any one image of the first to fourth image blocks G11-G14). Specifically, in this event, the microcomputer 4 commands that the image dividing section 30 should supply an image signal corresponding to one problematic image (for example, first image block G11) of the first to fourth image blocks G11-G14 to the first gamma processing section 41 and should output the image signals corresponding to three remaining images (for example, the second to fourth image blocks G12-G14) to the second gamma processing section 42. The microcomputer 4 also commands that the image dividing section 30 should output the boundary image between the one problematic image and the other three images to the two-dimensional lowpass filter 60.

The microcomputer 4 commands that the two-dimensional lowpass filter 60 should expand or narrow the range of smoothing processing in accordance with the type and degree of the problem in the one problematic image.

The microcomputer 4 commands that the image combining section 50 should combine the one problematic image, the other three images and their boundary image (for example, the image adjacent to the L-shaped borderline illustrated in FIG. 23(C)).

(2-3) When determining that the first and second image blocks G11, G12 should not be divided based on the result of the foregoing (1-1) detection operation by the histogram detector 1, and based on the result of the foregoing (1-2) detection operation by the histogram detector 1, if determining that there is at least one problem of the following three problems for any two images not adjacent to each other of the first to fourth image blocks G11-G14 (combination of image G11 and image G14 or combination of image G11 and image G14): too dark; can cause screen burn-in; the light/dark difference with the adjoining image is too large, the microcomputer 4 determines that the first to fourth image blocks G11-G14 should be divided mutually. Specifically, in this event, the microcomputer 4 determines that the image on the display screen 21 should be divided into four, for example, in such a manner as illustrated in FIG. 23(B).

In this event, the microcomputer 4 commands that the image dividing section 30 should divide the image on the display screen 21 into the first to fourth image blocks G11-G14 of FIG. 23(B) and should supply the image signal corresponding to each of the relevant image blocks to the first to fourth gamma processing sections 41-44. The microcomputer 4 also commands that the image dividing section 30 should supply the mutual the boundary image between the first to fourth image blocks G11-G14 (for example, the image adjacent to the cross-shaped borderline illustrated in FIG. 23(B)) to the two-dimensional lowpass filter 60.

The microcomputer 4 commands that the two-dimensional lowpass filter 60 should expand or narrow the range of smoothing processing in accordance with the types and degrees of the problems in the two problematic images.

In this regard, the boundary image may include the following four portions: a portion which is the boundary portion between the first image block G11 and the second image block G12, a portion which is the boundary portion between the first image block G11 and the third image block G13, a portion which is the boundary portion between the second image block G12 and the fourth image block G14, and a portion which is the boundary portion between the third image block G13 and the fourth image block G14. Therefore, the microcomputer 4 may command that the two-dimensional lowpass filter 60 should specify the range of smoothing processing for each of the four portions separately.

The microcomputer 4 commands that the image combining section 50 should combine the first image block G11, the second image block G12, the third image block G13, the fourth image block G14, and their boundary images.

(2-4) When determining that the first and second image blocks G11, G12 should not be divided based on the result of the foregoing (1-1) detection operation by the histogram detector 1, and based on the result of the foregoing (1-2) detection operation by the histogram detector 1, if determining that there is at least one problem of the following three problems for only the two images adjacent to each other of the first to fourth image blocks G11-G14 (for example, first and third image blocks G11, G13): too dark; can cause screen burn-in; the light/dark difference with the adjoining image is too large, and at the same time if determining that the two images adjacent to each other (for example, first and third image blocks G11, G13) have a problem of a different kind from each other (for example, “too dark” for one, “can cause burn-in” for the other). The microcomputer 4 determines that only the two images adjacent to each other (for example, the first and third image blocks G11, G13) out of the images on the entire display screen 21 should be divided independently from each other and that the two remaining images (for example, second and fourth image blocks G12, G14) should be left undivided. Specifically, in this event, the microcomputer 4 determines that the image on the display screen 21 should be divided into three, for example, in such a manner as illustrated in FIG. 23(D).

In this event, the microcomputer 4 commands that the image dividing section 30 should divide only the two images adjacent to each other, both of which have a problem (for example, first and third image blocks G11, G13) out of the images on the entire display screen 21 respectively and independently, and should leave the two remaining images undivided. Specifically, in this event, the microcomputer 4 commands that the image dividing section 30 should supply the image signal corresponding to either of the two images adjacent to each other, both of which have a problem (for example, first image block G1) to the first gamma processing section 41, should supply the image signal corresponding to the other image (for example, the third image block G13) to the second gamma processing section 42, and should supply the image signals corresponding to the two remaining images (for example, second and fourth image blocks G12, G14) collectively to the third gamma processing section 43. The microcomputer 4 also commands that the image dividing section 30 should supply the two problematic images, the two remaining images, and the mutual boundary image (for example, the image adjacent to the T-shaped borderline illustrated in FIG. 23(D)) to the two-dimensional lowpass filter 60.

The microcomputer 4 commands that the two-dimensional lowpass filter 60 should expand or narrow the range of smoothing processing in accordance with the types and degrees of the problems in the two problematic images.

In this regard, the boundary image may include the following three portions: a portion which is the boundary portion between the first image block G11 and the second image block G12, for example, a portion which is the boundary portion between the first image block G11 and the third image block G13 in FIG. 23(D), and a portion which is the boundary portion between the third image block G13 and the fourth image block G14. Therefore, the microcomputer 4 may command that the two-dimensional lowpass filter 60 should specify the range of smoothing processing for each of the three portions separately.

The microcomputer 4 commands that the image combining section 50 should combine each of the image blocks, specifically, for example, the first image block G11, the third image block G13, the image comprising the second and fourth image blocks G12, G14 and their boundary images.

(2-5) When the determination does not correspond to any one of the foregoing (2-1) to (2-4), the microcomputer 4 determines that the first to fourth image blocks G11-G14 should not be divided.

In this event, the microcomputer 4 commands that the image dividing section 30 should output the image signal corresponding to the whole relevant image, for example, only to the first gamma processing section 41 without dividing the image on the display screen 21.

The image dividing section 30 divides the image displayed on the display screen 21 in accordance with a command from the microcomputer 4, for example, in the following four types of mode:

(3-1) When the microcomputer 4 makes the foregoing (2-1) determination, the image dividing section 30 divides the image on the display screen 21 into the first image block G11 and the second image block G12 of FIG. 23(A), supplies the image signal corresponding to one of the relevant image block to the first gamma processing section 41, the image signal corresponding to the other to the second gamma processing section 42, respectively, and supplies the image signal corresponding to the boundary image between each image to the two-dimensional lowpass filter 60.

(3-2) When the microcomputer 4 makes the foregoing (2-2) determination, the image dividing section 30 divides only any one problematic image of the images on the entire display screen 21 (any one image of the first to fourth image blocks G11-G14 in FIG. 23(B)), supplies the image signal corresponding to one image of the relevant image blocks to the first gamma processing section 41, the image signal corresponding to the remaining three images to the second gamma processing section 42, respectively, and supplies the boundary image between the one problematic image and the other three images to the two-dimensional lowpass filter 60.

(3-3) When the microcomputer 4 makes the foregoing (2-3) determination, the image dividing section 30 divides the image on the display screen 21 into four: the first to fourth image blocks G11-G14 of FIG. 23(B), supplies the image signal corresponding to the first image block G11 of the relevant image blocks to the first gamma processing section 41, the image signal corresponding to the second image block G12 to the second gamma processing section 42, the image signal corresponding to the third image block G13 to the third gamma processing section 43, the image signal corresponding to the fourth image block G14 to the fourth gamma processing section 44, respectively, and supplies the boundary image between the first to fourth image blocks G11-G14 to the two-dimensional lowpass filter 60.

(3-4) When the microcomputer 4 makes the foregoing (2-4) determination, the image dividing section 30 divides only the two images adjacent to each other, both of which have a problem out of the images on the entire display screen 21 respectively and independently, and leaves the two remaining images undivided. Specifically, the image dividing section 30 supplies the image signal corresponding to one of the two images adjacent to each other, both of which have a problem (for example, first image block G1 in FIG. 23(D)) to first gamma processing section 41, supplies the image signal corresponding to the other (for example, third image block G13 in FIG. 23(D)) to the second gamma processing section 42, supplies the image signal corresponding to the two remaining images (for example, second and fourth image blocks G12, G14 in FIG. 23(D)) collectively to the third gamma processing section 43, and supplies the boundary image between the two problematic images and the two remaining images to the two-dimensional lowpass filter 60.

(3-5) When the microcomputer 4 makes the foregoing (2-5) determination, the image dividing section 30 supplies the image signal corresponding to the image on the entire display screen 21 only for gamma processing.

Also, each of the gamma processing sections 41-44 applies gamma processing to the image signal input from the image dividing section 30 using the gamma curve selected according to the command from the microcomputer 4, and supplies the relevant processed image signal to the image combining section 50.

When the image is not divided, no image signal is input into the second to fourth gamma processing sections 42-44, and the second to fourth gamma processing sections 42-44 perform no gamma processing and supply no image signal to the image combining section 50.

When the image is divided into two, no image signal is input into the third and fourth gamma processing sections 43, 44, and the third and fourth gamma processing sections 43, 44 perform no gamma processing and supply no image signal to the image combining section 50.

Further, when the image is divided into three, no image signal is input into the fourth gamma processing section 44, and the relevant fourth gamma processing section 44 performs no gamma processing and supplies no image signal to the image combining section 50.

The two-dimensional lowpass filter 60 applies smoothing processing to the boundary image input from the image dividing section 30 (for example, the boundary image of the image in any one of FIGS. 23(A) to (D)) so as to supply to the image combining section 50.

When the image is not divided, no image signal is input to the two-dimensional lowpass filter 60, and the two-dimensional lowpass filter 60 performs no smoothing processing and supplies no image signal to the image combining section 50.

When an image is divided into two blocks, the image combining section 50 combines each of the image signals input from the first gamma processing section 41, the second gamma processing section 42 and the two-dimensional lowpass filter 60 so as to supply the combined signal to the display unit 20. When an image is divided into three, the image combining section 50 combines each of the image signals input from the first gamma processing section 41, the second gamma processing section 42, the third gamma processing section 43 and the two-dimensional lowpass filter 60 so as to supply the combined signal to the display unit 20. When an image is divided into four, the image combining section 50 combines each of the image signals input from the first gamma processing section 41, the second gamma processing section 42, the third gamma processing section 43, the fourth gamma processing section 44 and the two-dimensional lowpass filter 60 so as to supply the combined signal to the display unit 20. When an image is not divided, the image combining section 50, for example, supplies the image signal on the entire display screen 21 input from the first gamma processing section 41 to the display unit 20 with no change.

Next, the operation in the second operation mode of this embodiment will be described.

First, the microcomputer 4 commands the histogram detector 1, for example, to detect the respective luminance level distributions of the first image block G11 and the second image block G12 in FIG. 23(A).

The histogram detector 1 then detects the respective luminance level distributions of the first image block G 11 and the second image block G12 in FIG. 23(A) and supplies the relevant detection result data to the microcomputer 4.

The microcomputer 4, based on the data of the two luminance level distributions, determines whether or not the image on the display screen 21 should be divided into the first image block G11 and the second image block G12 in FIG. 23(A).

In this regard, the microcomputer 4, for example, when only either one of the first image block G11 or the second image block G12 in FIG. 23(A) is too dark, when only either of them can cause screen burn-in, or when the light/dark difference between both images G11, G12 is too large, determines that the first and second image blocks G11, G12 should be divided.

When determining that the first and second image blocks G11, G12 in FIG. 23(A) should be divided, the microcomputer 4 gives a command to the image dividing section 30 accordingly.

The image dividing section 30 divides the image into the first and second image blocks G11, G12 in FIG. 23(A) according to the command. Among these, the image dividing section 30 supplies the image signal corresponding to the first image block G11 to the first gamma processing section 41, the image signal corresponding to the second image block G12 to the second gamma processing section 42, and the image signal corresponding to the boundary image between the first and second image blocks G11, G12 to the two-dimensional lowpass filter 60, respectively.

Also, the microcomputer 4 commands the first and second gamma processing sections 41, 42 similarly as has been described in the foregoing second embodiment, to select the most suitable gamma curve, reduce burn-in and improve image quality, respectively.

Further, the microcomputer 4 commands the two-dimensional lowpass filter 60 similarly as has been described in the foregoing second embodiment, to expand or narrow the range to which smoothing processing should be applied.

In addition, the microcomputer 4 commands the image combining section 50 that the smoothing processing result by the two-dimensional lowpass filter 60 should be reflected on the image.

On the other hand, when determining that the first and second image blocks G11, G12 in FIG. 23(A) should not be divided, the microcomputer 4 commands the histogram detector 1 to detect the respective luminance level distributions of the first image block G11, the second image block G12, the third image block G13 and the fourth image block G14 in FIG. 23(B).

The histogram detector 1 then detects the respective luminance level distributions of the first to fourth image blocks G11-G14 in FIG. 23(B) and outputs the relevant detection result data to the microcomputer 4.

The microcomputer 4, based on the data of the four luminance level distributions, determines whether or not the image on the display screen 21 should be divided into any one of the first to fourth image blocks G1′-G14 in FIG. 23(B).

In this regard, the microcomputer 4, for example, when any one of the first to fourth image blocks G11-G14 in FIG. 23(B) is too dark, when any image of them can cause screen burn-in, or when the light/dark difference between any images adjacent to each other is too large, determines that the image should be divided.

Specifically, for example, when only any one image of the first to fourth image blocks G11-G14 (for example, first image block G11), is too dark, can cause screen burn-in or the light/dark difference with another image is too large, the microcomputer 4 determines that only the relevant one image of the images on the entire display screen 21 (for example, first image block G11) should be divided (foregoing (2-2) determination).

Alternatively, for example, when only any two images not adjacent to each other of the first to fourth image blocks G11-G14 (for example, first and fourth image blocks G11, G14) are too dark, when only the relevant two images can cause screen burn-in, or when the light/dark difference with each adjoining image in the relevant two images is too large, the microcomputer 4 determines that the first to fourth image blocks G11-G14 should be divided mutually (foregoing (2-3) determination).

Alternatively, for example, when two images adjacent to each other of the first to fourth image blocks G11-G14 (for example, first and third image blocks G11, G13) are too dark or can cause screen burn-in, or when the light/dark difference with the adjoining image is too large, and at the same time, when the image qualities of the two images adjacent to each other (for example, first and third image blocks G11, G13) are mutually different (for example, “too dark” for one, “can cause burn-in” for the other, or the like), the microcomputer 4 determines that the two images adjacent to each other (for example, first and third image blocks G11, G13) out of the images on the entire display screen 21 should be divided (foregoing (2-4) determination).

The microcomputer 4, when determining that the first to fourth image blocks G11-G14 in FIG. 23(B) should be divided, gives a command for specifying how to divide the image to the image dividing section 30 as described above.

The image dividing section 30, according to the command, divides appropriately the image, for example, as in FIG. 23(B), FIG. 23(C) or FIG. 23(D). Among these, the image dividing section 30 outputs the image signal corresponding to the first image to the first gamma processing section 41, the image signal corresponding to the second image to the second gamma processing section 42, the image signal corresponding to the third image to the third gamma processing section 43, the image signal corresponding to the fourth image to the fourth gamma processing section 44, and the image signal corresponding to the boundary image between each of the image blocks to the two-dimensional lowpass filter 60, respectively. When dividing in such a manner as in FIG. 23(C), there are no third and fourth images and when dividing in such a manner as in FIG. 23(D), there is no fourth image.

The microcomputer 4 commands any one of the two to four processing sections 41 to 44 into which the image signal is input out of the first to fourth gamma processing sections 41 to 44 similarly as has been described in the foregoing seventh embodiment, to select the most suitable gamma curve, reduce burn-in and improve image quality, respectively.

Further, the microcomputer 4 commands the two-dimensional lowpass filter 60 similarly as has been described in the foregoing seventh embodiment, to expand or narrow the range to which smoothing processing should be applied.

In addition, the microcomputer 4 commands the image combining section 50 that the smoothing processing result by the two-dimensional lowpass filter 60 should be reflected on the image.

On the other hand, when determining that any one of the first to fourth image blocks G11-G14 in FIG. 23(B) should not be divided (foregoing (2-5) determination), the microcomputer 4 commands the image dividing section 30 not to divide the image. In this event, the image dividing section 30 supplies the image signal corresponding to the image on the entire display screen 21, for example, only to the first gamma processing section 41, and the first gamma processing section 41 applies a standard gamma processing to the image signal uniformly so as to supply the processed signal to the image combining section 50. Also, the image combining section 50 supplies the image signal from the first gamma processing section 41 to the display unit 20 with no change.

After that, the determination based on the luminance level distributions of the first and second image blocks G11, G12 in FIG. 23(A) and the determination based on the luminance level distributions of the first to fourth image blocks G11-G14 in FIG. 23(B) are repeated continuously and similarly, in accordance with the determination result, the microcomputer 4 applies gamma processing respectively and separately to the image by dividing it or applies gamma processing to the image uniformly without dividing the image.

According to the above eighth embodiment, in addition to the similar effects as in the foregoing seventh embodiment, the following effects can be achieved.

Specifically, according to the eighth embodiment, since the image division boundary is determined in the second operation mode based on the luminance level distribution detected by the histogram detector 1, an image can be divided with the most suitable division boundary and gamma processing can be applied to each of the image blocks separately.

While the foregoing eighth embodiment has been described for an example in which an image can be divided into up to four blocks, an image may be divided into five blocks or more.

Specifically, as subdividing the image area to be detected for luminance level distribution sequentially for example, divided by two, divided by four, divided by eight . . . , the division number and division boundary of an image are preferably determined.

Furthermore, the foregoing eighth embodiment has been described for an example in which, for example, when either of the images obtained by dividing by two is too dark or can cause screen burn-in, the division number and division boundary of the image is immediately determined. However, when either of the images obtained by dividing by two is too dark or when either of them can cause screen burn-in, the most suitable division boundary of the image is preferably determined by further subdividing the relevant one image. Specifically, for example, when either of the first and second image blocks G11, G12 in FIG. 23(A) is too dark or can cause screen burn-in, the relevant one image (for example, first image block G11) is divided into the first image block 11 and the third image block 13 in FIG. 23(B) and each luminance level distribution of the relevant image blocks is determined. When only either (for example, the third image block G13) is dark or when only either (for example, the third image block G13) can cause screen burn-in even by the relevant determination, only the image (for example, the third image block G13) may be divided from another portion. When the luminance level distributions of both images differ little in the relevant determination, without the division into the first and third image blocks 11, 13 in FIG. 23(B), the division into the first and second image blocks G11, G12 in FIG. 23(B) may be carried out.

Exemplary Modification

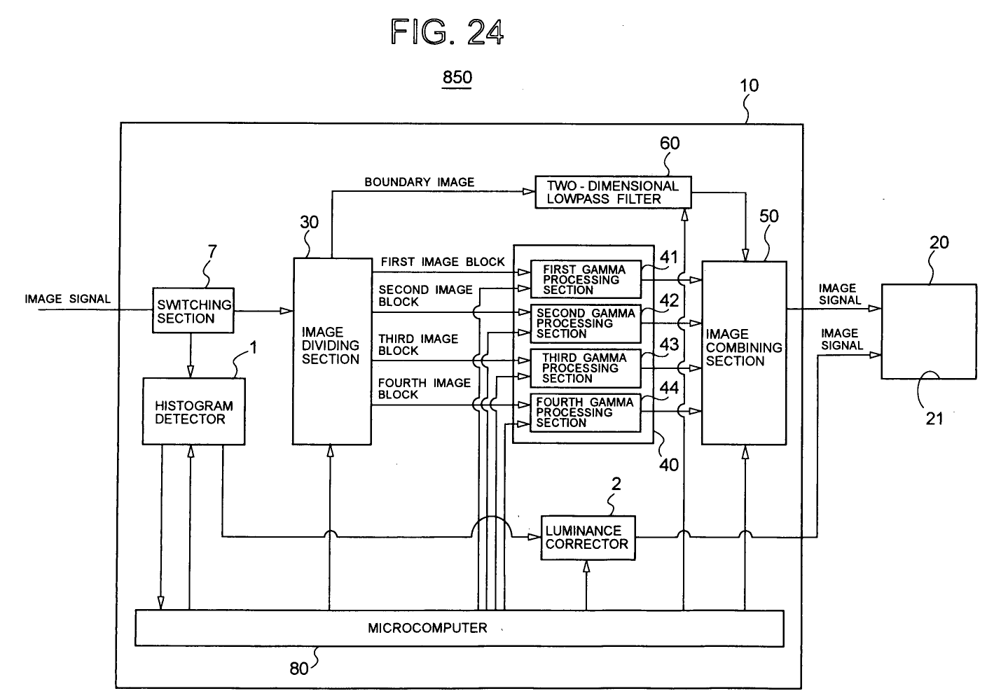

FIG. 24 is a block diagram illustrating the configuration of a display device 850 which is an exemplary modification of the eighth embodiment.

The foregoing eighth embodiment has been described for an example in which the histogram detector 1 is provided at a front stage to the image dividing section 30 as illustrated in FIG. 22. However, for example, as illustrated in FIG. 24, an image signal (image signal corresponding to the entire display screen 21) may be input alternatively through the switching section 7 to the image dividing section 30 (in the second operation mode) or to the histogram detector 1 (in the first operation mode). Similar effects to the above can be achieved in this configuration accordingly.

### Ninth Embodiment

While the foregoing sixth to eighth embodiments have been described for an example in which the image division boundary by the image dividing section 30 is preliminarily set or automatically set based on the luminance level distribution detected by the histogram detector (histogram detector 1 or 70), the ninth embodiment will be described for an example in which the image division boundary is set by a user's operation.

While the foregoing sixth to eighth embodiments have been described for an example in which the range to which smoothing processing is applied is automatically determined by the two-dimensional lowpass filter 60, the ninth embodiment will be described for an example in which the smoothing processing range is also set by a user's operation.

Further, while the foregoing sixth to eighth embodiments have been described for an example in which whether or not the smoothing processing result by the two-dimensional lowpass filter 60 should be reflected is automatically determined, the ninth embodiment will be described for an example in which whether or not the smoothing processing result by the two-dimensional lowpass filter 60 should be reflected is also set by a user's operation.

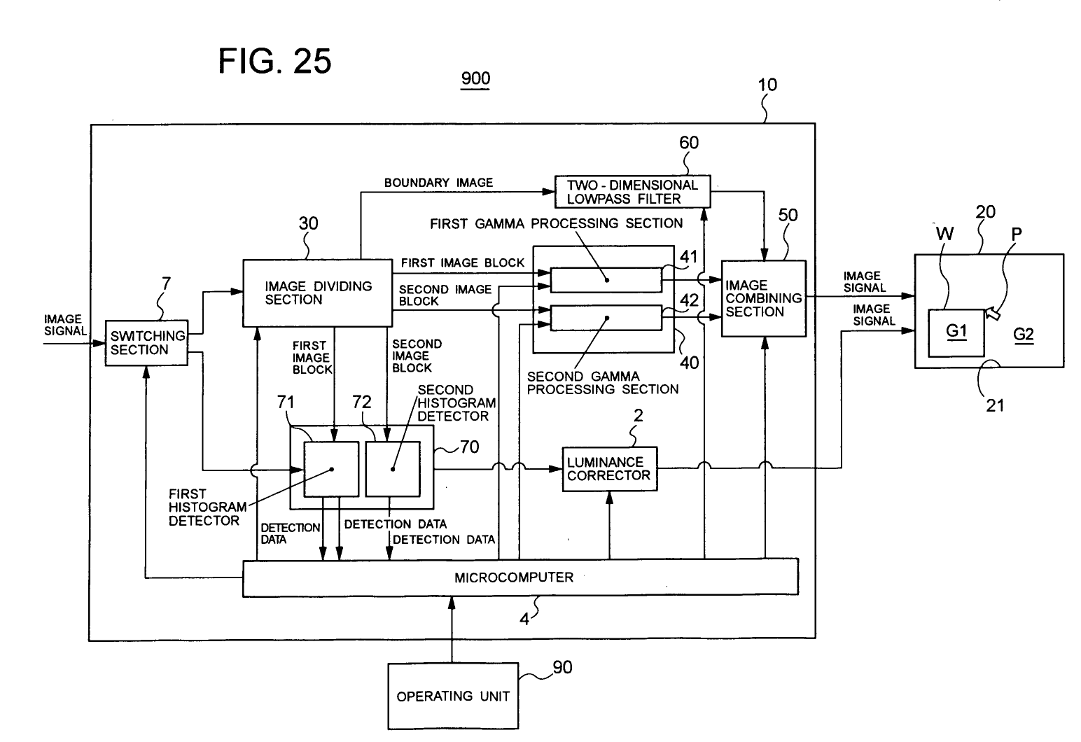

FIG. 25 is a block diagram illustrating the configuration of a display device 900 which is a ninth embodiment of the present invention.

Since the display device 900 of the ninth embodiment is different from the display device 700 of the foregoing seventh embodiment only in the following respects to be described, but is configured similarly to the display device 700 of the seventh embodiment in other respects, the components in the display device 900 of the ninth embodiment similar to those in the display device 700 have the same reference numerals and the descriptions thereof are omitted.

As illustrated in FIG. 25, in this embodiment, the display device 900 comprises an operating unit 90 operated by a user. The operating unit 90 comprises Graphical User Interface (GUI), for example, a mouse and an operation key (operation button).

The operating unit 90, when detecting a user's operation, supplies a detection signal in accordance with the kind of the operation, to the microcomputer 4. The microcomputer 4, in accordance with the kind of the detection signal input from the operating unit 90, supplies a command signal to an image dividing section 30, a two-dimensional lowpass filter and an image combining section 50.

In this embodiment, the image dividing section 30, for example, is configured so as to divide an image only in response to the command from the microcomputer 4. When the microcomputer 4 gives no command, the image dividing section 30 supplies the image signal corresponding to the image of the entire display screen 21 only to the first gamma processing section 41, without dividing the image.

Accordingly, when the microcomputer 4 gives no command to the image dividing section 30, only the first gamma processing section 41 performs gamma processing and supplies an image signal to the image combining section 50 whereas the second gamma processing section 42 performs no gamma processing and supplies no image signal to the image combining section 50.

When the microcomputer 4 gives no command to the image dividing section 30, the histogram detector 70 detects no luminance level distribution, the two-dimensional lowpass filter 60 performs no smoothing processing, and the image combining section 50 supplies the image signal input from the first gamma processing section 41 to the display unit 20 with no change without combining the image.

Next, an operation in the ninth embodiment will be described.

First, in accordance with the image displayed on the display screen 21, a user determines whether or not the image should be divided, and operates an operating unit 80 to divide the image into two with a desired borderline when dividing.

Here, examples of image division include cases when a clock image, a channel number image or subtitle images for a movie are displayed, when recognizing that there are two screen signals on one screen (simultaneous reporting for news programs or the like, for example, one for relay point, the other for broadcast studio) or when an image in which light/dark difference between a dark portion and a bright portion is displayed.

When dividing an image, an operation for starting the image division is conducted to the operating unit 90. For example, a pointer P (see FIG. 25) or an indicator is then displayed on the display screen 21.

The user specifies the range of the image to be divided, for example, by moving the pointer P. Specifically, for example, since a rectangular frame W is displayed within the display screen 21 in accordance with the movement track of the pointer P, after dragging operation for adjusting the position, size and shape of the frame W to be suited to the user's taste, the user conducts an operation for determining the image range.

In this regard, the pointer P and the frame W are displayed, for example, by fitting the picture data stored in a memory section (not shown) into the image combining section 50 under the control of the microcomputer 4.

The shape of the frame W is not limited to be rectangular, for example, the area surrounded by the arbitrary movement track of the pointer P may be used as the frame W.

The image range is thus determined using the operating unit 80, and the microcomputer 4 then supplies a command signal to the image dividing section 30 so as to divide the image into two blocks with the frame W as a borderline.

On receiving the command signal from the microcomputer 4, the image dividing section 30 divides the image into two with the frame W as a borderline. The image dividing section 30 supplies the image signal corresponding to one image (for example, first image block G1) to the first gamma processing section 41, and the image signal corresponding to the other image (for example, second image block G2) to the second gamma processing section 42, respectively, and supplies the boundary image between the first image block G1 and the second image block G2 (the boundary image G3: omitted in FIG. 25) to the two-dimensional lowpass filter 60.

Further, the image dividing section 30 supplies the image signal corresponding to the divided two images, specifically the first image block G1 and the second image block G2 to the first histogram detector 71 and the second histogram detector 72, respectively.

The microcomputer 4 conducts determination operation and controls the first gamma processing section 41 and the second gamma processing section 42 based on the determination result similarly as has been described in the foregoing seventh embodiment.

The first gamma processing section 41 and the second gamma processing section 42 select a gamma curve respectively according to the command by the microcomputer 4, and apply gamma processing on the image signal using the relevant selected gamma curve so as to supply the processed image signal to the image combining section 50.

On the other hand, the two-dimensional lowpass filter 60 applies smoothing processing to the image of the range determined by the user in the previous setting operation out of the boundary image G3 so as to supply the processed image signal to the image combining section 50.

The image combining section 50 combines the first image block G1 from the first gamma processing section 41, the second image block G2 from the second gamma processing section 42 and the boundary image G3 from the two-dimensional lowpass filter 60, and supplies the image signal after combining to the display unit 20.

The display unit 20 displays an image based on the image signal from the image combining section 50.

Next, the user, checking the image display, determines the image range to which the smoothing processing of the boundary area between the first image block G1 and the second image block G2 should be applied and determines whether or not smoothing processing is required.

Specifically, for example, when thinking that the image is degraded due to too wide range for smoothing processing operation, the user conducts the operation for narrowing the image range to which smoothing processing should be applied, to the operating unit 90.

The microcomputer 4 then supplies a control command for narrowing the image range to which smoothing processing should be applied, to the two-dimensional lowpass filter 60. The two-dimensional lowpass filter 60, receiving the control command, narrows the image range to which smoothing processing should be applied.

On the other hand, when thinking that the image borderline is prominent due to too narrow range for smoothing processing, the user conducts the operation for expanding the image range to which smoothing processing should be applied, to the operating unit 90.

The microcomputer 4 then supplies a control command for expanding the image range to which smoothing processing should be applied, to the two-dimensional lowpass filter 60. The two-dimensional lowpass filter 60, receiving the control command, expands the image range to which smoothing processing should be applied.

When thinking that smoothing processing on the boundary image G3 itself is not required, the user conducts an operation such that the result of smoothing processing will not be reflected, to the operating unit 90. The microcomputer 4 then supplies a control command such that the result of smoothing processing will not be reflected, to the image combining section 50. The image combining section 50, receiving the control command, prevents the smoothing processing result from being reflected.

According to the above ninth embodiment, in addition to the similar effects as in the foregoing seventh embodiment, the following effects can be achieved.

Specifically, according to the ninth embodiment, the user can set the division boundary of an image by using the image dividing section 30, the image range to which smoothing processing is applied by the two-dimensional lowpass filter 60, whether valid or not for smoothing processing by the two-dimensional lowpass filter 60 (whether or not the result is reflected) respectively and arbitrarily by operating the operating unit 90.

The foregoing ninth embodiment has been described for an example in which the division boundary of an image by the image dividing section 30, the image range to which smoothing processing is applied by the two-dimensional lowpass filter 60, whether valid or not for smoothing processing by the two-dimensional lowpass filter 60 can be selected respectively and arbitrarily by a user. However, in addition to these selecting operations, the gamma processing section 40 may be configured so that the operation mode of the gamma processing can arbitrarily be selected by a user. Specifically, for example, the user's operation of the operating unit 90 may increase the number of grayscale levels of a dark image or reduce the light/dark difference in the image which likely to cause burn-in. When a user can select gamma processing mode in the gamma processing section 40 arbitrarily, the histogram detector 70 may not be provided.

While the foregoing ninth embodiment has been described for an example in which a user can set the position, size and shape of the frame W to be the division boundary of an image arbitrarily, but for example, options for the division boundary of an image may preliminarily be provided so that the division boundary of an image can be determined by selecting a desired division boundary from the provided options. Specifically, for example, as illustrated in FIG. 23(B), a user may select any one or more of the four image blocks (arbitrary number within the range of 1 to 3) by the operation to the operating unit 90 so that the image dividing section 30 can divide the relevant selected image.

### Tenth Embodiment

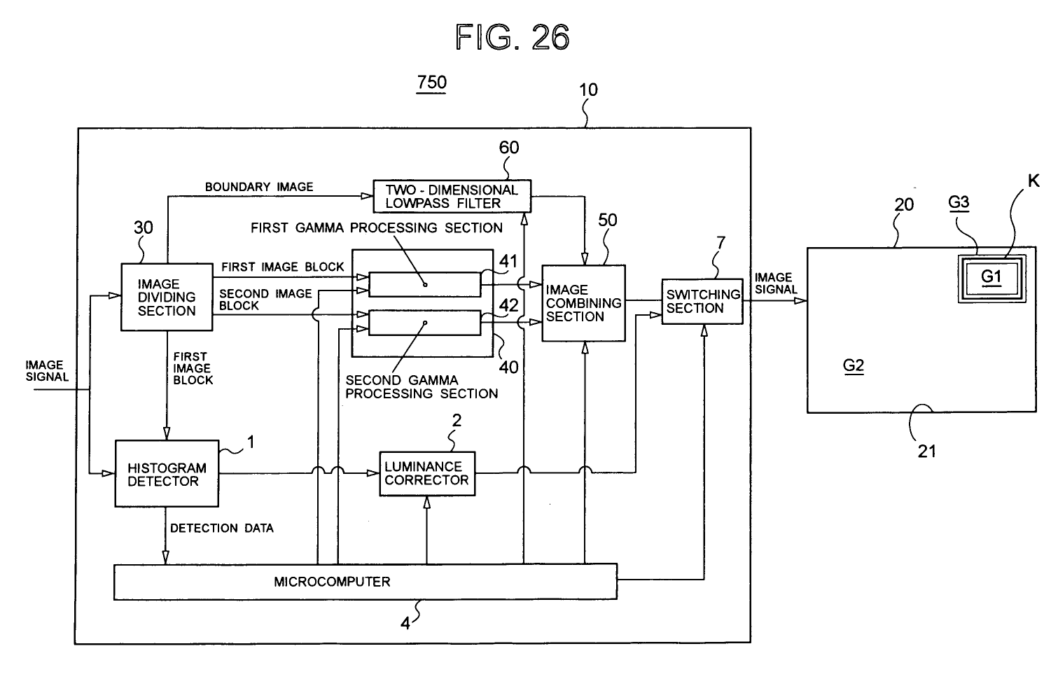

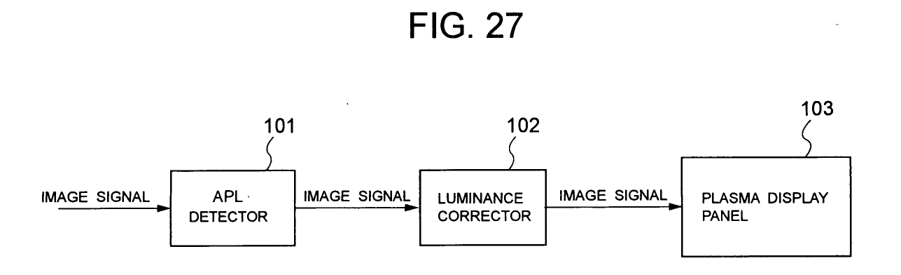

FIG. 26 illustrates the configuration of a display device 750 which is a tenth embodiment of the present invention.

While each of the foregoing sixth to ninth embodiments has been described for an example in which the switching section 7 is provided at a front stage to the image dividing section 30 and the histogram detector (histogram detector 1, 70), the tenth embodiment will be described for an example in which a switching section 7 is arranged at a latter stage of an image combining section 50 and a luminance corrector 2.

Since the display device 750 of the tenth embodiment is different from the display device 600 of the foregoing sixth embodiment only in the following respects to be described, but is configured similarly to the display device 600 of the sixth embodiment in other respects, the components in the display device 750 of the tenth embodiment similar to those in the display device 600 have the same reference numerals and the descriptions thereof are omitted.

In this embodiment, an input image signal branched at a front stage to the image dividing section 30 and the histogram detector 1 is input into the image dividing section 30 and the histogram detector 1, respectively.

Gamma processing by the image dividing section 30, the histogram detector 1, a gamma processing section 40, a two-dimensional lowpass filter 60, an image combining section 50 and a microcomputer 4, and luminance correction processing by the histogram detector 1, a luminance corrector 2 and the microcomputer 4 are performed in parallel, and the image signal as the respective processing results are supplied to the switching section 7 from the image combining section 50 and the luminance corrector 2, respectively.

In the switching section 7, in accordance with the control signal from the microcomputer 4, while only the image signal input from the luminance corrector 2 is selectively transferred to a display unit 20 in the first operation mode, only the image signal input from the image combining section 50 is selectively transferred to the display unit 20 in the second operation mode.

As a result, in the display unit 20, while an image is displayed based on the image signal to which luminance correction processing is applied by the histogram detector 1, the luminance corrector 2 and the microcomputer 4 in the first operation mode, in the second operation mode an image is displayed based on the image signal to which gamma processing is applied by the image dividing section 30, the histogram detector 1, the gamma processing section 40, the two-dimensional lowpass filter 60, the image combining section 50 and the microcomputer 4.

According to the tenth embodiment as described above, the similar effects as in the foregoing sixth embodiment can be achieved.

While the tenth embodiment has been described for an example in which the display device 600 according to the sixth embodiment is partially changed, the change in which the switching section 7 is arranged at a latter stage of the image combining section 50 and the luminance corrector 2 can be applied to each of the seventh to ninth embodiments similarly as in this embodiment.

Although the foregoing sixth to tenth embodiments have been described for an example in which the switching section 7 is provided, this invention is not limited to this example, and the switching section 7 may be omitted. Specifically, for example, if the gamma processing by the image dividing section 30, the histogram detector 1 (70), the gamma processing section 40, the two-dimensional lowpass filter 60, the image combining section 50 and the microcomputer 4, and the luminance correction processing by the histogram detector 1 (70), the luminance corrector 2 and the microcomputer 4 are performed in parallel, at the same time, if it is configured so that an image signal is alternatively supplied from the image combining section 50 or the luminance corrector 2 to the display unit 20 in accordance with the control signal from the microcomputer 4, the switching section 7 may be omitted.

While the foregoing sixth to tenth embodiments have been described for an example in which a functional block for gamma processing (image dividing section 30, histogram detector 1 (70), gamma processing section 40, two-dimensional lowpass filter 60, image combining section 50 and microcomputer 4) and a functional block for luminance correction processing (histogram detector 1 (70), luminance corrector 2 and microcomputer (4) share the microcomputer 4 and the histogram detector 1 (70), the functioning portion for gamma processing and the functional block for the luminance correction processing may comprise either or both of the microcomputer 4 and the histogram detector 1 (70) respectively and separately.

Also, while the foregoing sixth to ninth embodiments have been described for an example in which gamma processing is performed as nonlinear processing, examples of the nonlinear processing include contrast control processing, sharpness control processing, noise reduction processing and color correction processing.

Also, as the nonlinear processing, any one of gamma processing, contrast control processing, sharpness control processing, noise reduction processing and color correction processing may be performed on at least any one image of each portion obtained by dividing an image into a plurality of portions (preferably, each image obtained by dividing separately) or, two or more processes may also be performed.

Also, while the foregoing sixth to ninth embodiments have been described for an example in which luminance level distribution is detected in a histogram form, but in essence, any statistical distribution of luminance levels may only have to be recognized, so that the luminance level distribution may be represented in another statistical graph.

Further, as has been described in the foregoing sixth to tenth embodiments, the configuration in which image processing is applied to the image block signals from the image dividing section 30 before the combination of the image blocks by the image combining section 50 by using the image dividing section 30 and the image combining section 50, is not limited to a case in which nonlinear processing (gamma processing or the like) is performed, and is similarly applicable to a case in which luminance correction processing is performed. Specifically, for example, as has been described in the foregoing second to fourth embodiments, when luminance level distribution is detected in a partial display area of one display screen to correct the luminance level in this display area, for example, the image dividing section 30 is arranged at a front stage to the histogram detector 1 and the image combining section 50 is arranged at a latter stage of the luminance corrector 2. Further, in that case, as required, the histogram detector 1 and the luminance corrector 2 may be provided in each image signal transmission course from the image dividing section 30 onward, separately and respectively. Further, for performing luminance correction processing as in the second to fourth embodiments, when the image dividing section 30 and the image combining section 50 are provided, the two-dimensional lowpass filter (the boundary image processing means) 60 is preferably provided, which has been described in the foregoing sixth to tenth embodiments, and in this configuration, the boundary portion between image blocks to be combined can be smoothed.

Also, while each of the foregoing embodiments has illustrated a plasma display device as the display device 10, the present invention is not limited to this example, but can be applied to other display devices.

It is understood that the foregoing description and accompanying drawings set forth the preferred embodiments of the invention at the present time. Various modifications, additions, and alternative will, of course, become apparent to those skilled in the art in light of the foregoing teachings without departing from the spirit and scope of the disclosed invention. Thus, it should be appreciated that the invention is not limited to the disclosed embodiments but may be practiced within the full scope of the appended claims.

This application is based on Japanese Patent Applications No. 2004-131092, No. 2004-07412 and No. 2004-208895 which are hereby incorporated by reference.

1. A burn-in reduction device for reducing screen burn-in on a display device, comprising:
luminance level distribution detecting means for detecting a statistical distribution with respect to luminance levels of pixels of an image based on an input image signal; and
luminance changing means for changing a luminance level of the input image signal in accordance with the statistical distribution detected by said luminance level distribution detecting means.

2. A burn-in reduction device according to claim 1, wherein said luminance level distributing means detects the statistical distribution for an entire area of one display screen.

3. A burn-in reduction device according to claim 1, wherein said luminance level distribution detecting means detects the statistical distribution for a partial display area of one display screen.

4. A burn-in reduction device according to claim 3, wherein:
said luminance level distribution detecting means detects the statistical distribution for each of a plurality of display areas of the one display screen, and
said luminance changing means changes the luminance levels of the input image signal in accordance with the statistical distribution for at least one of the plurality of display areas.

5. A burn-in reduction device according to claim 1, wherein:
said luminance level distribution detecting means includes a first luminance level distribution detecting means and a second luminance level distribution detecting means, said first luminance level distribution detecting means detecting the statistical distribution for an entire area of one display screen, and said second luminance level distribution detecting means detecting the statistical distribution for a partial display area of one display screen;
and said luminance changing means changes the luminance level of the input image signal in accordance with the statistical distribution detected by at least one of said first and second luminance level distribution detecting means.

6. A burn-in reduction device according to claim 1, further comprising detection area changing means for changing a display area intended for the detection of the statistical distribution by said luminance level distribution detecting means.

7. A burn-in reduction device according to claim 6, wherein said detection area changing means includes:
storing means for storing display area specifying data for specifying a display area intended for the detection of the statistical distribution; and
specifying data re-writing means for re-writing the display area specifying data in said storing means,
wherein said luminance level distribution detecting means detects the statistical distribution for a display area specified by the display area specifying data stored in said storing means.

8. A burn-in reduction device according to claim 6, wherein said detection area changing means changes the display area intended for the detection of the statistical distribution to either an entire area of one display screen or each of a plurality of areas into which one display screen are divided.

9. A burn-in reduction device according to claim 1, wherein:
said luminance level distribution detecting means detects a statistical distribution of the number of pixels with respect to luminance levels, and
said luminance changing means changes the luminance level of the input image signal in accordance with the number of pixels at the respective luminance levels.

10. A burn-in reduction device according to claim 9, wherein:
said luminance level distribution detecting means detects the statistical distribution of the number of pixels with respect to at least three luminance levels including a black level, a white level, and an intermediate level, and
said luminance changing means changes the luminance level of the input image signal in accordance with the number of pixels at each of the three luminance levels.

11. A burn-in reduction device according to claim 10, wherein said luminance changing means changes the luminance level of the input image signal in accordance with an inequality relationship among the numbers of pixels at the three luminance levels.

12. A burn-in reduction device according to claim 10, wherein:
said luminance changing means changes the luminance level of the input image signal in accordance with the number of pixels at a specific luminance level of luminance levels included in white levels.

13. A burn-in reduction device according to claim 10, wherein:
said luminance changing means changes the luminance level of the input image signal when the input image signal satisfies all of the conditions:
a first condition defining that the number of pixels at the white level is larger than a first threshold, and smaller than a second threshold;
a second condition defining that the number of pixels at the intermediate level is smaller than a third threshold;
a third condition defining that the number of pixels at the black level is larger than the number of pixels at the intermediate level; and
a fourth condition defining that the number of pixels at the black level is larger than the number of pixels at the white level.

14. A burn-in reduction device according to claim 13, wherein said third condition is satisfied when the number of pixels at the black level is twice or more larger than the number of pixels at the intermediate level.

15. A burn-in reduction device according to claim 13, wherein said third condition is satisfied when the number of pixels at the black level is three times or more larger than the number of pixels at the intermediate level.

16. A burn-in reduction device according to claim 13, wherein said fourth condition is satisfied when the number of pixels at the black level is twice or more larger than the number of pixels at the white level.

17. A burn-in reduction device according to claim 13, wherein said fourth condition is satisfied when the number of pixels at the black level is three times or more larger than the number of pixels at the white level.

18. A burn-in reduction device according to claim 10, wherein:
said luminance changing means changes the luminance level of the input image signal when the input image signal satisfies all of the conditions:
one of a fifth condition defining that the number of pixels at the black level is larger than a fourth threshold, and a sixth condition defining that the number of pixels at the intermediate level is larger than the fourth threshold; and
a seventh condition defining that the number of pixels at a specific luminance level of luminance levels included in white levels is larger than a fifth threshold.

19. A burn-in reduction device according to claim 1, wherein said luminance level distributing means detects the statistical distribution for the input image signal with respect to the luminance levels as a histogram representation.

20. A burn-in reduction device according to claim 1, wherein said luminance changing means changes the luminance level of the input image signal when the statistical distribution with respect to the luminance levels continues to be a distribution required for the change of the luminance level for a time period longer than a predetermined time period.

21. A burn-in reduction device according to claim 1, wherein said luminance changing means changes the luminance level of the input image signal by reducing a luminance of the input image signal.

22. A burn-in reduction device according to claim 1, wherein said luminance changing means changes the luminance level of the input image signal by reducing a luminance of a pixel at a white level.

23. A burn-in reduction device according to claim 1, wherein said luminance changing means changes the luminance level of the input image signal by reducing a luminance of a pixel at a specific luminance level of luminance levels included in white levels.

24. A burn-in reduction device according to claim 21, wherein said luminance changing means changes the luminance level of the input image signal by reducing the luminance of the pixel by a predetermined ratio.

25. A burn-in reduction device according to claim 21, wherein said luminance changing means changes the luminance level of the input image signal by reducing the luminance level of the pixel by a higher ratio as luminance levels of the surrounding pixels becomes lower.

26. A burn-in reduction device according to claim 1, further comprising:
image dividing means for dividing an image to be displayed of the input image signal into a plurality of blocks;
image combining means for combining the plurality of blocks obtained by said image dividing means;
nonlinear processing means for performing nonlinear processing on at least one of the blocks obtained by said image dividing means, before said image combining means combines the blocks; and
operation mode selecting means for selecting either a first operation mode or a second operation mode, said first operation mode being a mode in which an image signal having the luminance level changed by said luminance changing means is supplied for display, and said second operation mode being a mode in which an image signal on which image processing is performed by said image dividing means, said image combining means and said nonlinear processing means is supplied for display.

27. A burn-in reduction device according to claim 26, wherein said image dividing means divides said image into a plurality of blocks in accordance with said statistical distribution detected by said luminance level distribution detecting means.

28. A burn-in reduction device according to claim 27, wherein:
said image dividing means divides said image into a relatively dark image and a relatively bright image, and
said nonlinear processing means performs nonlinear processing on said relatively dark image so as to increase the number of gradation levels.

29. A burn-in reduction device according to claim 27, wherein:
said image dividing means divides said image into an image relatively likely to cause screen burn-in and an image relatively unlikely to cause screen burn-in, and
said nonlinear processing means performs nonlinear processing on said image relatively likely to cause screen burn-in so that screen burn-in is reduced.

30. A burn-in reduction device according to claim 27, wherein:
said image dividing means divides said image into a relatively dark image and a relatively bright image, and
said nonlinear processing means performs the nonlinear processing so that a difference in luminance between said relatively dark image and said relatively bright image is reduced.

31. A burn-in reduction device according to claim 26, further comprising borderline specifying operation means for specifying a borderline in an image to be divided,
wherein said image dividing means divides said image into a plurality of blocks based on the specifying operation by said borderline specifying operation means.

32. A burn-in reduction device according to claim 26, wherein:
said nonlinear processing means performs said nonlinear processing on at least one of the blocks after the division by said image dividing means and before the combination of the blocks by said image combining means, in accordance with said statistical distribution detected by said luminance level distribution detecting means.

33. A burn-in reduction device according to claim 26, wherein:
said nonlinear processing means performs said nonlinear processing on each of the blocks after the division by said image dividing means and before the combination of the blocks by said image combining means, respectively and separately.

34. A burn-in reduction device according to claim 26, wherein:
said luminance level distribution detecting means detects the statistical distribution with respect to luminance levels of pixels included in at least one of the blocks obtained by said image dividing means, and
said nonlinear processing means performs the nonlinear processing on said at least one of the blocks in accordance with said statistical distribution detected by said luminance level distribution detecting means.

35. A burn-in reduction device according to claim 26, wherein:
said luminance level distribution detecting means detects the statistical distribution with respect to luminance levels of pixels included in each of the blocks obtained by said image dividing means, and
said nonlinear processing means performs the nonlinear processing respectively and separately on each of the blocks obtained by said image dividing means in accordance with corresponding statistical distribution selected from said statistical distributions detected by said luminance level distribution detecting means.

36. A burn-in reduction device according to claim 26, wherein said image dividing means determines an image area to be divided by said image dividing means, on the basis of at least one of the results:
a result obtained by dividing an image to be displayed over a display screen into blocks of a first division number and detecting said statistical distribution for each of the blocks by said luminance level distribution detecting means; and
a result obtained by dividing the image to be displayed over said display screen into blocks of a second division number larger than said first division number and detecting said statistical distribution for each of the blocks by said luminance level distribution detecting means.

37. A burn-in reduction device according to claim 26, wherein said luminance level distribution detecting means determines an image area to be divided by said image dividing means, at least through a process in which a range of the image area intended for detection of said statistical distribution by said luminance level distribution detecting means is reduced by stages.

38. A burn-in reduction device according to claims 26, further comprising determining means for determining whether or not said image dividing means and said nonlinear processing means should divide an image into a plurality of blocks and perform said nonlinear processing, respectively, when said second operation mode is selected.

39. A burn-in reduction device according to claim 38, wherein said determining means makes said determination based on said statistical distribution detected by said luminance level distribution detecting means.

40. A burn-in reduction device according to claim 26, comprising boundary image processing means for smoothing an image of a boundary area between the plurality of blocks obtained by said image dividing means.

41. A burn-in reduction device according to claim 40, wherein:
said image dividing means supplies an image signal corresponding to the image of a boundary area between said plurality of blocks to said boundary image processing means, and
said boundary image processing means smooths an image of an image signal supplied from said image dividing means and outputs the smoothed image signal to said image combining means.

42. A burn-in reduction device according to claim 40, wherein:
said boundary image processing means performs processing so as to gradually change a luminance or color of pixels in said boundary area between two adjoining blocks, from a luminance or color of one of the two adjoining blocks to a luminance or color of the other block, as the pixels get closer to the other block.

43. A burn-in reduction device according to claim 40, wherein said boundary image processing means includes a two-dimensional lowpass filter.

44. A burn-in reduction device according to claim 41, further comprising smoothing processing valid/invalid selecting operation means for selecting either validity or invalidity of smoothing processing by said boundary image processing means, wherein:
when an operation of selecting the validity is performed in said smoothing processing valid/invalid selecting operation means, said image combining means combines the smoothed image signal from said boundary image processing means and image signals corresponding to the image divided by said image dividing means; and
when an operation of selecting the invalidity is performed, said image combining means combines only image signals except the smoothed image signal from said boundary image processing means.

45. A burn-in reduction device according to claim 40, further comprising boundary area range specifying operation means for specifying a range of said display area of said boundary area in which an image is to be smoothed by said boundary image processing means,
wherein said boundary image processing means performs smoothing of an image in a range specified by said boundary area range specifying operation means.

46. A burn-in reduction device according to claim 26, wherein said nonlinear processing means performs gamma processing as said nonlinear processing.

47. A burn-in reduction device according to claim 26, wherein said nonlinear processing means performs contrast control processing as said nonlinear processing.

48. A burn-in reduction device according to claim 26, wherein said nonlinear processing means performs sharpness control processing as said nonlinear processing.

49. A burn-in reduction device according to claim 26, wherein said nonlinear processing means performs noise reduction processing as said nonlinear processing.

50. A burn-in reduction device according to claim 26, wherein said nonlinear processing means performs color correction processing as said nonlinear processing.

51. A burn-in reduction device according to claim 26, wherein said nonlinear processing means performs at least one of gamma processing, contrast control processing, sharpness control processing, noise reduction processing and color correction as said nonlinear processing.

52. A burn-in reduction device according to claim 26, further comprising:
nonlinear processing specifying operation means for specifying an operation mode of a nonlinear processing to be performed by said nonlinear processing means, wherein,
said nonlinear processing means performs nonlinear processing in a manner depending on an operation mode specified by said nonlinear processing specifying operation means.

53. A display apparatus comprising:
a burn-in reduction unit for reducing screen burn-in on a display device, including luminance level distribution detecting means for detecting a statistical distribution with respect to luminance levels of pixels of an image based on an input image signal; and luminance changing means for changing a luminance level of the input image signal in accordance with the statistical distribution detected by said luminance level distribution detecting means; and
a display unit for displaying an image based on the input image signal.

54. A display apparatus according to claim 53, wherein said display device is a plasma display device including a plasma display panel as said display unit.

55. A display apparatus according to claim 54, wherein said luminance changing means gradually changes a sustain frequency in said plasma display panel upon the change of the luminance level.

56. A method of reducing screen burn-in on a display device, comprising the steps of:
detecting a statistical distribution with respect to luminance levels of pixels of an image based on an input image signal; and
changing a luminance level of the input image signal in accordance with the statistical distribution.

57. A program executable by a computer, for causing the computer to perform the steps of:
detecting a statistical distribution with respect to luminance levels of pixels of an image based on an input image signal; and
changing a luminance level of the input image signal in accordance with the statistical distribution.
